(19) United States
(12) Patent Application Publication
(10) Pub. No.: US 2023/0388971 A1
(43) Pub. Date: Nov. 30, 2023

(54) PRACH PARTITIONING FOR FEATURE SIGNALING

(71) Applicant: Telefonaktiebolaget LM Ericsson (publ), Stockholm (SE)

(72) Inventors: Mattias Bergström, Sollentuna (SE); Johan Rune, Lidingö (SE); Oscar Ohlsson, Bromma (SE); Luca Feltrin, Solna (SE)

(21) Appl. No.: 18/031,654

(22) PCT Filed: May 20, 2022
(86) PCT No.: PCT/IB2022/054757

§ 371 Date: Apr. 13, 2023

Related U.S. Application Data
(60) Provisional application No. 63/191,141, filed on May 20, 2021.

(51) Int. Cl. H04W 72/02; H04W 74/08

(52) U.S. Cl. CPC H04W 72/02; H04W 74/0833

(57) ABSTRACT

Systems and methods are disclosed that relate to Physical Random Access Channel (PRACH) partitioning for feature signaling. In one embodiment, a method performed by a wireless communication device comprises receiving, from a network node, information that indicates mappings between a plurality of PRACH resources and a plurality of sets of features. The method further comprises selecting a PRACH resource from among the plurality of PRACH resources, the selected PRACH resource being mapped to one of the plurality of sets of features that the wireless communication device desires to indicate to the network node. The method further comprises transmitting a PRACH preamble using the selected PRACH resource. In this manner, signaling of features can be done in a manner that is radio resource efficient, backwards compatible, and future compatible.

### RELATED APPLICATIONS

This application claims the benefit of provisional patent application Ser. No. 63/191,141, filed May 20, 2021, the disclosure of which is hereby incorporated herein by reference in its entirety.

### TECHNICAL FIELD

The present disclosure relates to a cellular communications system and, more specifically, to signaling of features via Physical Random Access Channel (PRACH) partitioning.

### BACKGROUND

### Random Access in New Radio (NR)

Random Access (RA) is performed when the User Equipment (UE) wants to transition from idle/inactive to connected state to e.g., transmit data or signaling. Similar to Long Term Evolution (LTE), New Radio (NR) uses a 4-step random access procedure consisting of the following steps, as illustrated in FIG. 1.
1. The UE transmits a preamble (also known as Msg1) on the Physical Random Access Channel (PRACH).
2. The network (i.e., gNB) responds with a Random Access Response (RAR) (also known as Msg2) indicating reception of the preamble and providing a time-alignment command adjusting the transmission timing of the UE based on the timing of the received preamble.
3-4. The UE and network exchange messages (uplink message Msg3 and subsequent downlink message Msg4) to resolve potential collisions due to simultaneous transmission of the same preamble from multiple devices within the cell. If successful, Msg4 also transfers the UE to connected state.
   Once the random access is completed, the UE is in connected state and subsequent communication is performed using dedicated channels.

In addition to the basic 4-step random access procedure described above, NR Release 16 also supports a 2-step random access procedure consisting of only two messages, namely, MsgA and MsgB, where MsgA basically replaces Msg1+Msg3 and MsgB basically replaces Msg2+Msg4. The 2-step random access procedure is illustrated in FIG. 2. The 2-step random access procedure reduces the idle-to-connected transition time but is in practice limited to small cells where the timing advance is 0 since the Msg3 (or PUSCH) part of MSGA is sent before the uplink timing alignment is established.

What is described above is the so-called contention-based random access procedure where there is no coordination among the UEs and the same preamble may therefore be sent from multiple UEs at the same time. In connected mode, there is also a contention-free random access procedure, which is used, e.g., during handover, where the network assigns a dedicated preamble for the UE to use in the random access procedure and hence there are no collisions. However, in this document, we will mainly focus on the contention-based random access procedure.

### PRACH Resources Configuration for 4-Step Random Access

For 4-step RA, the PRACH time/frequency resources are configured in system information, more specifically in the RACH-ConfigCommon Information Element (IE) in System Information Block 1 (SIB1), and consist of a number of slots (the PRACH slots) that repeats itself every PRACH configuration period. Within these PRACH slots, there may be multiple frequency domain PRACH occasions which lie consecutively in the frequency domain and each occupying a certain number of resource blocks that depends on the preamble transmission bandwidth. Two types of preamble format are defined: a long format used for larger cells and a short format for smaller cells. For the short preambles, it is in some cases possible to have multiple preamble transmissions multiplexed in time within a single PRACH slot. In other words, for short preambles, there may not only be multiple PRACH occasions in the frequency domain but also in the time domain. In each such PRACH time/frequency occasion, there are 64 preambles available for transmission. The PRACH resource structure is illustrated in FIG. 3.

A key feature of random access in NR is the possibility to establish a suitable beam pair and to apply receiver side analog beam-sweeping for the preamble reception. This is achieved by associating different Synchronization Signal Blocks (SSBs) with different PRACH time/frequency occasions and/or different preambles. As different SSBs correspond to different downlink beams, the network is able to determine the downlink beam from the preamble reception. Furthermore, if the SSBs are mapped so that, at a given time, all PRACH occasions in frequency are mapped to the same SSB, the network will also be able to apply analog beam-sweeping for the preamble reception.

Each SSB is mapped to a number of PRACH occasions. This number can be less than one meaning that the PRACH occasion is shared by multiple SSBs (in this case separation is done based on preamble partitioning, see below), or it can be larger than one to, e.g., enable analog beam-sweeping for the preamble reception. The mapping of SSBs to PRACH occasions is done in the following order:
First in increasing order of preamble indexes within a single PRACH occasion;
Then in the frequency domain for the frequency multiplexed PRACH occasions;
Then in time domain for the time multiplexed PRACH occasions within a PRACH slot (assuming short-preamble format is used);
Then finally in the time domain between PRACH slots

When the UE performs random access, the UE will select the first available PRACH occasion corresponding to the selected downlink beam/SSB for the preamble transmission. If there is more than one PRACH occasion to choose from (i.e., if an SSB is mapped to multiple PRACH occasions in the frequency domain), the UE will select one at random.

FIG. 4 shows an example where there are two downlink beams/SSBs in the cell and both SSBs are mapped to the same PRACH occasion, i.e. the SSBs are separated using preamble partitioning rather than PRACH occasion partitioning in this example. There are two PRACH slots per PRACH period and six PRACH occasions per PRACH slot.

In the time domain, the PRACH configuration (including the position and length of PRACH occasions) is determined by the prach-ConfiguationIndex in the RACH-ConfigGeneric IE, wherein the prach-ConfiguationIndex points at a row in one out of three tables specified in 3GPP Technical Specification (TS) 38.211 V16.0.0 (Table 6.3.3.2-2, Table 6.3.3.2-3 and Table 6.3.3.2-4), wherein the applicable table is determined by the carrier frequency and type of duplex scheme, i.e. Frequency Division Duplexing (FDD) or Time Domain Duplexing (TDD). As an example, the first rows from Table 6.3.3.2-2 in 3GPP TS 38.211, which applies to FDD deployment in Frequency Range 1 (FR1), is recited below.

TABLE 6.3.3.2-2
Random access configurations for FR1 and paired spectrum/supplementary uplink.

| | | | | | | | Nₜ^{RA, slot}, | |
|---|---|---|---|---|---|---|---|---|
| | | | | | | | number of | |
| | | | | | | | time- | |
| | | | | | | | domain | |
| | | | | | | Number of | PRACH | |
| | | | | | | PRACH | occasions | |
| PRACH | | | | | | slots | within a | N_{dur}^{RA}, |
| Configuration | Preamble | n_{SFN} mod x = y | | Subframe | Starting | within a | PRACH | PRACH |
| Index | format | x | y | number | symbol | subframe | slot | duration |
| 0 | 0 | 16 | 1 | 1 | 0 | — | — | 0 |
| 1 | 0 | 16 | 1 | 4 | 0 | — | — | 0 |
| 2 | 0 | 16 | 1 | 7 | 0 | — | — | 0 |
| 3 | 0 | 16 | 1 | 9 | 0 | — | — | 0 |
| 4 | 0 | 8 | 1 | 1 | 0 | — | — | 0 |
| . . . | | | | | | | | |

The 64 preambles within a PRACH occasion are divided equally among the SSBs sharing the PRACH occasion and are then split into a contention-based and a contention-free part. The contention-based preambles associated with an SSB can also be further split into an A and B group, where the group B preambles are used to request a larger Msg3 size in the contention-based random access procedure. The overall division of the preambles is illustrated in FIG. 5. Note that it is also possible to reserve some of the 64 preambles for other use, e.g. for (Msg1-based) on-demand system information request.

The contention-free preambles associated with an SSB are used in the contention-free random access procedure used during, e.g., handover. Since the present disclosure is mainly concerned with the contention-based random access procedure, the details of the contention-free preambles will not be discussed further.

### PRACH Resources for 2-Step Random Access

2-step RA introduced in Release 16 uses PRACH partitioning to enable the network to distinguish the 2-step RA attempts from the 4-step RA attempts in order to simplify the decoding of the Msg3 (PUSCH) part of MSGA.

The PRACH time/frequency resources (i.e., the PRACH occasions) for 2-step RA are configured in the broadcasted system information (more specifically in the RACH-ConfigCommonTwoStepRA IE in SIB1) and can either be separate from 4-step RA or they can be shared with 4-step RA. In the separate case, the 2-step RA UEs can be distinguished based on the PRACH occasion while, in the shared case, this is not possible and preamble partitioning must be used instead. The preamble partitioning is done by expanding the SSB-associated contention-based preamble region and allocating the preambles in the expansion to 2-step RA. The 2-step RA preambles can then be split into an A and B group similar to the 4-step contention-based preambles. As can be seen from FIG. 6, the end result is that the SSB-associated contention-based preambles have been split into four partitions:
4-step RA
   group A (partition 00)
   group B (partition 01)
2-step RA
   group A (partition 10)
   group B (partition 11)
      (If the partition index is written in binary like above the 0s and 1s can be interpreted as a feature being on and off, e.g. 01 means that the 2-step RA feature is off and the group B feature is on).

Note that, if shared PRACH occasions are used for 2-step RA and 4-step RA, the SSB-associated contention-based preambles used for 2-step RA still looks like contention-free preambles to a Rel-15 UE. There is therefore no risk that a Rel-15 UE uses the 2-step RA preambles which makes the solution backwards compatible.

### SUMMARY

Systems and methods are disclosed that relate to Physical Random Access Channel (PRACH) partitioning for feature signaling. In one embodiment, a method performed by a wireless communication device comprises receiving, from a network node, information that indicates mappings between a plurality of PRACH resources and a plurality of sets of features. The method further comprises selecting a PRACH resource from among the plurality of PRACH resources, the selected PRACH resource being mapped to one of the plurality of sets of features that the wireless communication device desires to indicate to the network node. The method further comprises transmitting a PRACH preamble using the selected PRACH resource. In this manner, signaling of features can be done in a manner that is radio resource efficient, backwards compatible, and future compatible.

In one embodiment, each PRACH resource of the plurality of PRACH resources is mapped to a different one of the plurality of sets of features.

In one embodiment, at least one of the plurality of sets of features is mapped to more than one of the plurality of PRACH resources.

In one embodiment, two or more of the plurality of PRACH resources, but not all of the plurality of PRACH resources, are mapped to a same set of features.

In one embodiment, each set of features from among the plurality of sets of features comprises one or more features.

In one embodiment, the information that indicates the mappings between the plurality of PRACH resources and the plurality of sets of features comprises, for each PRACH configuration of one or more PRACH configurations, information that indicates a mapping of all PRACH resources of the PRACH configuration to a particular set of features.

In one embodiment, the information that indicates the mappings between the plurality of PRACH resources and the plurality of sets of features comprises, for a PRACH configuration, information that indicates a mapping of a first subset of PRACH resources of the PRACH configuration to a first set of features and information that indicates a mapping of a second subset of the PRACH resources of the PRACH configuration to a second set of features.

In one embodiment, the plurality of PRACH resources are defined by a PRACH configuration, and the information that indicates the mappings between the plurality of PRACH resources and the plurality of sets of features comprises, for the PRACH configuration, information that indicates a mapping of different subsets of the plurality of PRACH resources defined by the PRACH configuration to different sets of features.

In one embodiment, the different subsets of the plurality of PRACH resources comprise different sets of preambles within a PRACH resource.

In one embodiment, the information that indicates the mappings between the plurality of PRACH resources and the plurality of sets of features comprises, for a PRACH resource from among the plurality of PRACH resources, information that indicates a mapping of a first set of PRACH preambles for the PRACH resource to a first set of features and information that indicates a mapping of a second set of the PRACH preamble for the PRACH resource to a second set of features.

In one embodiment, the information that indicates the mappings between the plurality of PRACH resources and the plurality of sets of features comprises, for each PRACH resource, a set of flags that indicates a set of features mapped to the PRACH resource.

In one embodiment, the information that indicates the mappings between the plurality of PRACH resources and the plurality of sets of features comprises at least one bitmap.

In one embodiment, the information that indicates the mappings between the plurality of PRACH resources and the plurality of sets of features comprises, for each PRACH resource, a bitmap that indicates a set of features mapped to the PRACH resource. In one embodiment, the selected PRACH resource is a PRACH resource for which the respective bitmap indicates only the desired set of features. In one embodiment, a size of the bitmap is greater than a number of features that is currently possible to map to the PRACH resource.

In one embodiment, features that can be signaled via PRACH have an assumed order, and the information that indicates the mappings between the plurality of PRACH resources and the plurality of sets of features defines a PRACH partitioning in an inductive manner.

In one embodiment, features that can be signaled via PRACH have an assumed order, and the information that indicates the mappings between the plurality of PRACH resources and the plurality of sets of features.

In one embodiment, a first PRACH resource of the plurality of PRACH resources or a subset of the first PRACH resource and a second PRACH resource of the plurality of PRACH resources or a subset of the second PRACH resource are mapped to a same set of features. In one embodiment, the desired set of features to be indicated to the network node is the same set of features to which the first PRACH resource of the plurality of PRACH resources or the subset of the first PRACH resource and the second PRACH resource of the plurality of PRACH resources or the subset of the second PRACH resource are mapped, and selecting the PRACH resource comprises selecting either: (a) the first PRACH resource of the plurality of PRACH resources or the subset of the first PRACH resource or (b) the second PRACH resource of the plurality of PRACH resources or the subset of the second PRACH resource, in accordance with a selection scheme. In one embodiment, the selection scheme is a randomized selection scheme. In another embodiment, the selection scheme is such that a probability of selection of equal among the possible PRACH. In another embodiment, the selection scheme is such that a probability of selection of a PRACH resource is based on a number of PRACH preambles in the PRACH resource. In another embodiment, the selection scheme is such that a particular PRACH preamble is selected and all preambles in the possible PRACH resources have equal probability of being selected. In another embodiment, the selection scheme is such that a probability of selection of a PRACH resource from the possible PRACH resources is based on a number of PRACH preambles in the PRACH resource and an amount of time until the PRACH resource. In another embodiment, the selection scheme is a selection scheme that selects a PRACH resource that is next in time.

In one embodiment, the plurality of PRACH resources are associated to a new PRACH. In one embodiment, the information that indicates the mappings between the plurality of PRACH resources and the plurality of sets of features comprises at least one bitmap. In another embodiment, the information that indicates the mappings between the plurality of PRACH resources and the plurality of sets of features comprises, for each feature of a plurality of features, a bitmap that indicates one or more of the plurality of PRACH resources that are mapped to the feature.

In one embodiment, the plurality of PRACH resources form a plurality of PRACH occasions, the plurality of PRACH occasions being a common pool of PRACH occasions dedicated for feature signaling, and the information that indicates the mappings between the plurality of PRACH resources and the plurality of sets of features comprises, for each of a plurality of features, a feature configuration that comprises information that indicates one or more PRACH occasions from the common pool of PRACH occasions dedicated for feature signaling that are mapped to the feature. In one embodiment, the plurality of PRACH occasions and/or associated preamble ranges are prepared to simplify indications of the mappings from the feature configurations. In one embodiment, a mapping between a feature and one or more preamble ranges in a PRACH resource to which the feature is mapped is defined based on a rule(s).

Corresponding embodiments of a wireless communication device are also disclosed. In one embodiment, a wireless communication device is adapted to receive, from a network node, information that indicates mappings between a plurality of PRACH resources and a plurality of sets of features. The wireless communication device is further adapted to select a PRACH resource from among the plurality of PRACH resources, the selected PRACH resource being mapped to one of the plurality of sets of features that the wireless communication device desires to indicate to the network node. The wireless communication device is further adapted to transmit a PRACH preamble using the selected PRACH resource.

In another embodiment, a wireless communication device comprises one or more transmitters, one or more receivers, and processing circuitry associated with the one or more transmitters and the one or more receivers. The processing circuitry is configured to cause the wireless communication device to receive, from a network node, information that indicates mappings between a plurality of PRACH resources and a plurality of sets of features. The processing circuitry is further configured to cause the wireless communication device to select a PRACH resource from among the plurality of PRACH resources, the selected PRACH resource being mapped to one of the plurality of sets of features that the wireless communication device desires to indicate to the network node. The processing circuitry is further configured to cause the wireless communication device to transmit a PRACH preamble using the selected PRACH resource.

Embodiments of a method performed by a network node are also disclosed. In one embodiment, a method performed by a network node comprises sending, to a wireless communication device, information that indicates mappings between a plurality of PRACH resources and a plurality of sets of features.

In one embodiment, each PRACH resource of the plurality of PRACH responses is mapped to a different one of the plurality of sets of features.

In one embodiment, at least one of the plurality of sets of features is mapped to more than one of the plurality of PRACH resources.

In one embodiment, two or more of the plurality of PRACH resources, but not all of the plurality of PRACH resources, are mapped to a same set of features.

In one embodiment, each set of features from among the plurality of sets of features comprises one or more features.

In one embodiment, the information that indicates the mappings between the plurality of PRACH resources and the plurality of sets of features comprises, for each PRACH configuration of one or more PRACH configurations, information that indicates a mapping of all PRACH resources of the PRACH configuration to a particular set of features.

In one embodiment, the information that indicates the mappings between the plurality of PRACH resources and the plurality of sets of features comprises, for a PRACH configuration, information that indicates a mapping of a first subset of PRACH resources of the PRACH configuration to a first set of features and information that indicates a mapping of a second subset of the PRACH resources of the PRACH configuration to a second set of features.

In one embodiment, the plurality of PRACH resources are defined by a PRACH configuration, and the information that indicates the mappings between the plurality of PRACH resources and the plurality of sets of features comprises, for the PRACH configuration, information that indicates a mapping of different subsets of the plurality of PRACH resources defined by the PRACH configuration to different sets of features.

In one embodiment, the information that indicates the mappings between the plurality of PRACH resources and the plurality of sets of features comprises, for a PRACH resource from among the plurality of PRACH resources, information that indicates a mapping of a first set of PRACH preambles for the PRACH resource to a first set of features and information that indicates a mapping of a second set of the PRACH preamble for the PRACH resource to a second set of features.

In one embodiment, the information that indicates the mappings between the plurality of PRACH resources and the plurality of sets of features comprises at least one bitmap.

In one embodiment, the information that indicates the mappings between the plurality of PRACH resources and the plurality of sets of features comprises, for each PRACH resource, a bitmap that indicates a set of features mapped to the PRACH resource. In one embodiment, a size of the bitmap is greater than a number of features that is currently possible to map to the PRACH resource.

In one embodiment, the information that indicates the mappings between the plurality of PRACH resources and the plurality of sets of features comprises, for each PRACH resource, a set of flags that indicates a set of features mapped to the PRACH resource.

In one embodiment, features that can be signaled via PRACH have an assumed order, and the information that indicates the mappings between the plurality of PRACH resources and the plurality of sets of features defines a PRACH partitioning in an inductive manner.

In one embodiment, features that can be signaled via PRACH have an assumed order, and the information that indicates the mappings between the plurality of PRACH resources and the plurality of sets of features.

In one embodiment, a first PRACH resource of the plurality of PRACH resources or a subset of the first PRACH resource and a second PRACH resource of the plurality of PRACH resources or a subset of the second PRACH resource are mapped to a same set of features.

In one embodiment, the plurality of PRACH resources are associated to a new PRACH. In one embodiment, the information that indicates the mappings between the plurality of PRACH resources and the plurality of sets of features comprises at least one bitmap. In another embodiment, the information that indicates the mappings between the plurality of PRACH resources and the plurality of sets of features comprises, for each feature of a plurality of features, a bitmap that indicates one or more of the plurality of PRACH resources that are mapped to the feature.

In one embodiment, the plurality of PRACH resources form a plurality of PRACH occasions, the plurality of PRACH occasions being a common pool of PRACH occasions dedicated for feature signaling, and the information that indicates the mappings between the plurality of PRACH resources and the plurality of sets of features comprises, for each of a plurality of features, a feature configuration that comprises information that indicates one or more PRACH occasions from the common pool of PRACH occasions dedicated for feature signaling that are mapped to the feature. In one embodiment, the plurality of PRACH occasions and/or associated preamble ranges are prepared to simplify indications of the mappings from the feature configurations. In one embodiment, a mapping between a feature and one or more preamble ranges in a PRACH resource to which the feature is mapped is defined based on one or more rules.

Corresponding embodiments of a network node are also disclosed. In one embodiment, a network node is adapted to send, to a wireless communication device, information that indicates mappings between a plurality of PRACH resources and a plurality of sets of features.

In another embodiment, a network node comprises processing circuitry configured to cause the network node to send, to a wireless communication device, information that indicates mappings between a plurality of PRACH resources and a plurality of sets of features.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the four-step random access procedure defined in Third Generation Partnership Project (3GPP) New Radio (NR);

FIG. 2 illustrates the two-step random access procedure defined in 3GPP NR;

FIG. 3 illustrates the Physical Random Access Channel (PRACH) resource structure;

FIG. 4 shows an example where there are two downlink beams/Synchronization Signal Blocks (SSBs) in a cell and both SSBs are mapped to the same PRACH occasion;

FIG. 5 illustrates the division of PRACH preambles;

FIG. 6 illustrates that the SSB-associated contention-based preambles are split into four partitions;

FIG. 7 illustrates one example of a cellular communications system in which embodiments of the present disclosure may be implemented;

FIG. 8 illustrates an example of preamble partitioning when feature F3 uses separate PRACH occasions;

FIG. 9 illustrates an example of preamble partitioning when feature F3 shares the PRACH occasions defined by the Release 15 group A/B feature, in accordance with one example embodiment of the present disclosure;

FIG. 10 shows an example where a 4×2 PRACH slot is defined (8 PRACH occasions) and are mapped to 2 SSBs both by setting N=2 and N=1/2, in accordance with one example embodiment of the present disclosure;

FIG. 11 is an illustration of preamble index ranges associated with two different features, where the overlap between the preamble ranges enables signaling of the combination of the features in accordance with an embodiment of the present disclosure;

FIG. 12 is an illustration of preamble index ranges associated with three different features and the overlaps between them that enables signaling of combinations of any two features, in accordance with one example embodiment of the present disclosure;

FIG. 13 is an illustration of preamble index ranges associated with three different features and the overlaps between them that enables signaling of combinations of any two features as well as the combination of all the three features, in accordance with one example embodiment of the present disclosure;

FIG. 14 is an illustration of an example of PRACH occasion partitioning and feature association when the feature association cycle spans two SSB to PRACH occasion mapping cycles, in accordance with one example embodiment of the present disclosure;

FIG. 15 is an illustration of an example of PRACH occasion partitioning and feature association when the feature association cycle spans two SSB to PRACH occasion mapping cycles, in accordance with one example embodiment of the present disclosure;

FIG. 16 is an illustration of an example of PRACH occasion partitioning and feature association when the feature association cycle spans two SSB to PRACH occasion mapping cycles, in accordance with one example embodiment of the present disclosure;

FIG. 17 illustrates the operation of a wireless communication device (e.g., a User Equipment (UE)) and a network node (e.g., a base station or a network node that implements some of the functionality of a base station) in accordance with at least some of the embodiments described herein;

FIGS. 18, 19, and 20 are schematic block diagrams of example embodiments of a network node;

FIGS. 21 and 22 are schematic block diagrams of example embodiments of a wireless communication device;

FIG. 23 illustrates an example embodiment of a communication system in which embodiments of the present disclosure may be implemented;

FIG. 24 illustrates example embodiments of the host computer, base station, and UE of FIG. 23; and

FIGS. 25, 26, 27, and 28 are flow charts that illustrate example embodiments of methods implemented in a communication system such as that of FIG. 23.

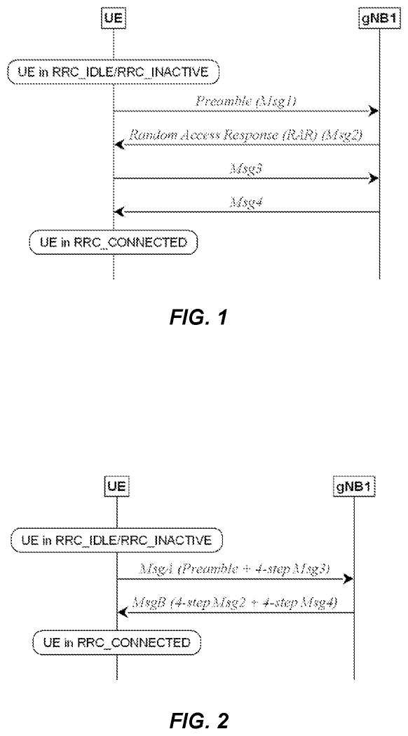

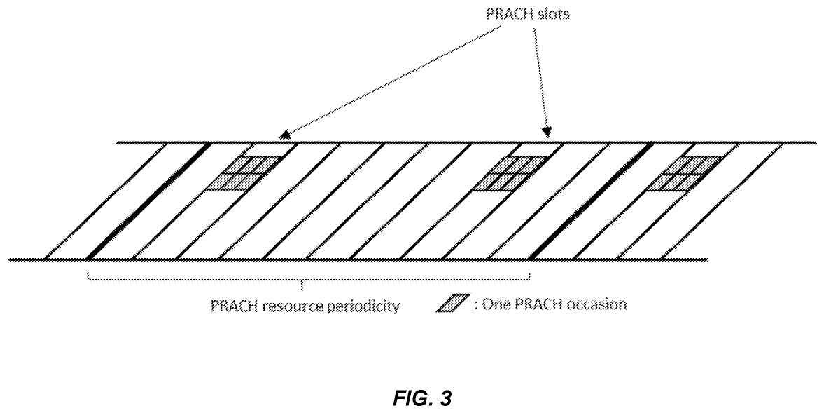

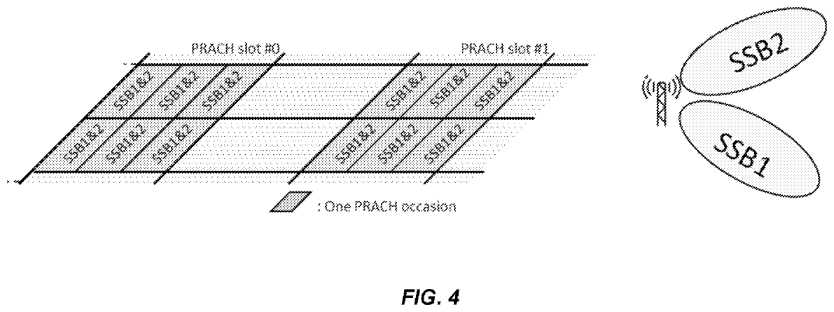

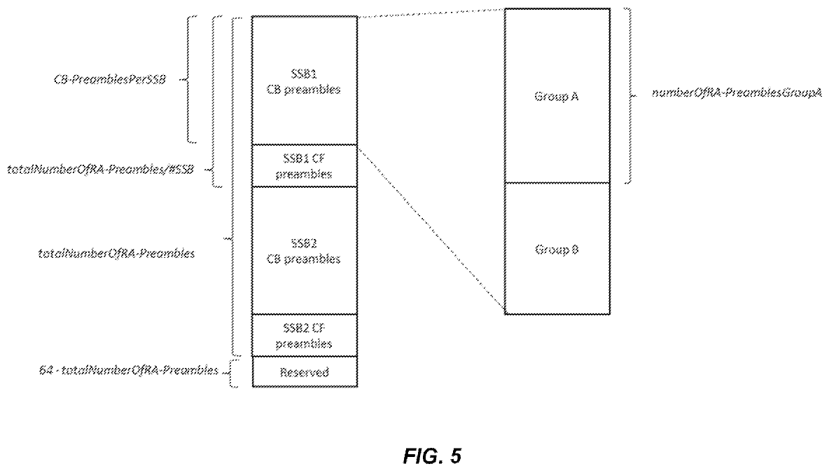

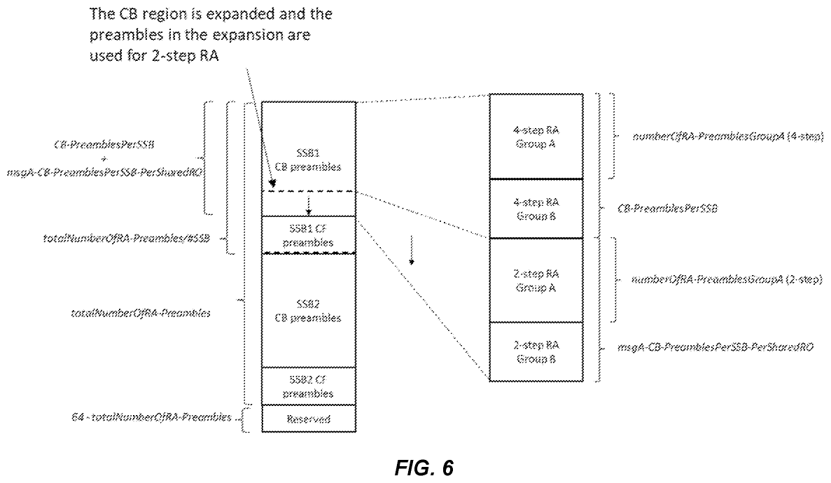

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). It is possible to convey additional information in the preamble transmission by means of Physical Random Access Channel (PRACH) partitioning. This means that the PRACH resources are partitioned and mapped to different information. The partitioning can either take place in the time/frequency domain (i.e., the PRACH occasions are partitioned) or in the coding domain (i.e., the PRACH preambles are partitioned), or a combination of the two. Based on the partition the preamble is received on, the network can decode the information. For example, as explained above, PRACH partitioning is used to convey the selected downlink beam/Synchronization Signal Block (SSB) to the network, to differentiate between 2-step and 4-step Random Access (RA), and to signal the Msg3/MsgA size using the group A/B preamble partitions.

In Release 17 of NR, which is currently being specified, several of the newly introduced features are considering making of use of PRACH partitioning (see Table 1 below). Typically, the intention with the PRACH partitioning is to indicate to the network whether the UE is using the Release 17 feature or not so that the network can adapt its behavior.

TABLE 1

| Rel-17 feature | Reason for PRACH indication |
|---|---|
| Reduced | To indicate reduced capabilities to the network so |
| Capabilities | that the network can adapt subsequent transmissions |
| (RedCap) | |
| Small Data | To request a larger Msg3 size (or MsgA size in case |
| Transmission | of 2-step RA) |
| (SDT) | |
| Coverage | To indicate need for coverage enhancement (esp. for |
| Enhancement | Msg3) |
| (CovEnh) | |
| Slicing | To indicate high priority slice to the network and to |
| | achieve slice isolation also during random access |

In general, the number of PRACH partitions grows exponentially with the number of features that are indicated via PRACH. For example, assuming binary (on/off) features and assuming that it should be possible to indicate all combinations of features, the total number of partitions is n×2\hat{ }k where n is the number of downlink beams/SSBs and k is the number of features. It is possible that some combinations of features can be excluded since some features may not be compatible with each other. For example, the small data feature is intended for UEs in good coverage and may therefore not be possible to combine with the coverage enhancement feature. Nevertheless, the number of combinations that potentially needs to be signaled via PRACH is still expected to be very large.

Due to the many combinations of features, there is a need to be able to partition the PRACH occasions and/or PRACH preambles and signal the partition configuration in an efficient manner.

### Brief Summary of Some Aspects of the Proposed Solutions

Certain aspects of the present disclosure and their embodiments may provide solutions to the aforementioned or other challenges. Systems and methods are disclosed herein in which PRACH resources are partitioned and mapped to different combinations of features. The mapping is indicated to the UE, and the UE selects the PRACH resource for preamble transmission corresponding to the feature(s) that the UE wants to indicate. In one embodiment, the partitioning is done in a manner which is:
Radio resource efficient—meaning that that the amount and periodicity of the PRACH resources in a partition can be adjusted according to the anticipated PRACH load and latency requirement of the corresponding feature combination,
Backwards compatible—meaning that the legacy UEs (i.e., pre-Rel-17 UEs or UEs which do not support the new features) will still be able to perform random access as before and will only use the PRACH partition(s) dedicated to the legacy UEs, and/or
Future compatible—meaning that the mapping solution is extensible if new features and feature combinations need to be supported in the future.

In one embodiment, a network node (e.g., a base station such as, e.g., a gNB) maps PRACH resources to different sets of features. The UE determines which set of features the UE wants to indicate in the random access procedure by inspecting the mappings of the possible PRACH resources and selects the PRACH resource which maps to the set of features that the UE wants to indicate.

In one example alternative embodiment, each feature configuration points out a PRACH resource that it is associated with, and the UE selects a PRACH resource which is associated with the feature that the UE wants to signal.

Certain embodiments may provide one or more of the following technical advantage(s). Embodiments of the PRACH partitioning disclosed herein may be done in a manner which is:
Radio resource efficient—meaning that that the amount and periodicity of the PRACH resources in a partition can be adjusted according to the anticipated PRACH load and latency requirement of the corresponding feature combination,
Backwards compatible—meaning that the legacy UEs (i.e., pre-Rel-17 UEs or UE which do not support the new features) will still be able to perform random access as before and will only use the PRACH partition(s) dedicated to the legacy UEs, and/or
Future compatible—meaning that the mapping solution is extensible if new features and feature combinations need to be supported in the future.

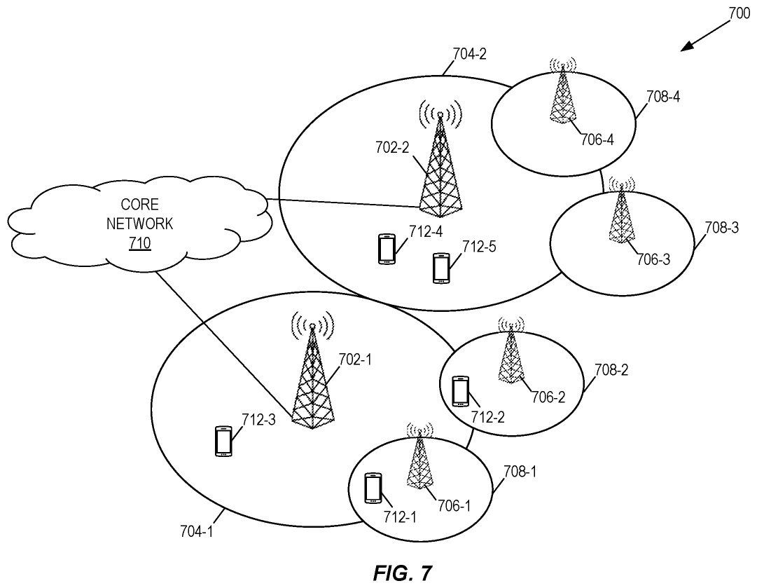

FIG. 7 illustrates one example of a cellular communications system 700 in which embodiments of the present disclosure may be implemented. In the embodiments described herein, the cellular communications system 700 is a 5G system (5GS) including a Next Generation RAN (NG-RAN) and a 5G Core (5GC); however, the embodiments disclosed herein are not limited thereto but may rather be used in any type of wireless communication system in which PRACH (or the like) partitioning is desired to be used to signal different sets of features. In this example, the RAN includes base stations 702-1 and 702-2, which in the 5GS include NR base stations (gNBs) and optionally next generation eNBs (ng-eNBs), controlling corresponding (macro) cells 704-1 and 704-2. The base stations 702-1 and 702-2 are generally referred to herein collectively as base stations 702 and individually as base station 702. Likewise, the (macro) cells 704-1 and 704-2 are generally referred to herein collectively as (macro) cells 704 and individually as (macro) cell 704. The RAN may also include a number of low power nodes 706-1 through 706-4 controlling corresponding small cells 708-1 through 708-4. The low power nodes 706-1 through 706-4 can be small base stations (such as pico or femto base stations) or RRHs, or the like. Notably, while not illustrated, one or more of the small cells 708-1 through 708-4 may alternatively be provided by the base stations 702. The low power nodes 706-1 through 706-4 are generally referred to herein collectively as low power nodes 706 and individually as low power node 706. Likewise, the small cells 708-1 through 708-4 are generally referred to herein collectively as small cells 708 and individually as small cell 708. The cellular communications system 700 also includes a core network 710, which in the 5GS is the 5GC. The base stations 702 (and optionally the low power nodes 706) are connected to the core network 710.

The base stations 702 and the low power nodes 706 provide service to wireless communication devices 712-1 through 712-5 in the corresponding cells 704 and 708. The wireless communication devices 712-1 through 712-5 are generally referred to herein collectively as wireless communication devices 712 and individually as wireless communication device 712. In the following description, the wireless communication devices 712 are oftentimes UEs and as such sometimes referred to herein as UEs 712, but the present disclosure is not limited thereto.

Now embodiments related to various aspects of the present disclosure will be described. While these embodiments are described under different headings, these embodiments may be used separately or in any desired combination.

### 1 Embodiment Group 1

### 1.1 PRACH Configurations are Mapped to Features

In one embodiment, the network (e.g., a network node such as, e.g., a base station 702 or a network node that implements part of the functionality of the base station 702 such as, e.g., a gNB-CU) indicates (e.g., to the wireless communication device 712 or UE) a mapping for a particular PRACH configuration, where the mapping indicates a set of features for which this PRACH configuration applies. For example:
PRACH resources of PRACH configuration X maps to a feature A
PRACH resources of PRACH configuration Y maps to a feature B
PRACH resources of PRACH configuration Z maps to the combination of feature A and feature B.

A PRACH configuration could, for example, be similar to the configuration conveyed in RACH-ConfigCommon Information Element (IE) used for 4-step RA or RACH-ConfigCommonTwoStepRA used for 2-step RA.

### 1.1.1 Subset of PRACH Resources of a RACH Configuration Point to a Set of Features

In a version of this embodiment, it is not all of the PRACH resources of a particular PRACH configuration that are mapped to a set of features as described above, but instead a subset of the PRACH resources of a particular PRACH configuration are mapped to a set of features. Different subsets of the PRACH resources of the particular PRACH configuration may map to different sets of features.

The “subsets of the PRACH resources” may include different sets of preambles within a PRACH resource. So, a first set of preambles maps to a first set of features, and a second set of preambles maps to a second set of features. For example:
Preamble set X1 of PRACH resource X maps to a feature A
Preamble set X2 of PRACH resource X maps to a feature B
Preamble set X3 of PRACH resource X maps to the combination of feature A and feature B.

The preamble sets may be defined as:
a range of preambles indexes, e.g. preamble index 10-17. This may be implemented in ASN.1 signaling so that the network indicates a first and a second index value and the indexes between those values belong to the preamble set.
a non-contiguous set of preamble indexes, e.g. preamble index 10, 12, 18. This may be implemented in signaling so that the network indicates an array of preamble indexes.

### 1.2 how to Define the Mapping

The mapping between different PRACH resources and different feature sets may be provided within a configuration(s) which defines the PRACH configuration(s). Different approaches are described below as to how to realize the mapping.

### 1.2.1 Approach with Bitmap

In one embodiment, the mapping may be realized using a bitmap. Each bit in the bitmap may be associated to a certain feature. For example, there may be four different features, feature A, feature B, feature C and feature D. The first bit in the bitmap may correspond to feature A, the second bit corresponds to feature B, the third to feature C and the fourth to feature D.

To indicate that a PRACH resource is associated to a certain feature or feature combination, the corresponding bit in the bitmap would be set to value 1 (or 0). And to indicate that a feature is not associated to this RA resource, the bitmap would be set to value 0 (or 1). To indicate association with a combination of features, the bit representing each feature in the combination would be set accordingly, e.g. set to 1 (or 0).

For example, the network would then signal the following:
if a certain PRACH resource is associated to feature A, the bitmap would be set to 1000,
if a certain PRACH resource is associated to feature B, the bitmap would be set to 0100, or
if a certain PRACH resource is associated to feature A and feature B, the bitmap would be set to 1100.

In one embodiment, absence of the bitmap means that the PRACH configuration is general and does not indicate any feature.

Note: That a PRACH resource is associated with feature X means that, if the UE uses this PRACH resource when transmitting a random access preamble, this signals that the UE supports feature X and/or that feature X is active in the UE and/or that the UE wants to use feature X and/or that the UE requests special treatment or support from the network to enable feature X.

When the UE wants to perform a random access procedure, it would first determine which features it wants to indicate during the random access procedure. The UE would then use a PRACH resource for which the bitmap has 1's (or 0's) for the features that the UE wants to indicate while the rest of the bits are 0's (or 1's). By using our example above, if it wants to indicate feature A and feature B, the UE should use a PRACH resource which is mapped to these two features, namely one which has a bitmap 1100 in the example above.

A UE may be required to inspect the complete bitmap to determine if the PRACH resource should be used or not for a particular random access attempt. That means that the UE may need to inspect bits in the bitmap which does not correspond to any feature which the UE is attempting a random access attempt for, and perhaps the UE might not even have implemented that feature. The reason is that if at least one bit in the bitmap is set to indicate association with a feature that the UE does not want to signal, then it cannot use this PRACH resource, even if the UE's intended features are all indicated in the bitmap as associated with the PRACH resource. In other words, the UE is allowed to use a PRACH resource only if the bits corresponding to the features it wants to use are set in the bitmap but no other bits.

The size of the bitmap may be defined to be larger than the number of features that are (currently) possible to map to a PRACH resource. For example, if there are four features which should be possible to map to PRACH resources, the bitmap may anyway be defined to be larger than 4, e.g. 10 bits. The reason for this is to make the solution futureproof and extendable. If in a later version or release of the specification, there may be a 5th feature which should now be possible to map to PRACH resources. If the UE of the earlier release is required to inspect the complete bitmap, it would mean that a network that is implementing the 5th feature may set the 5th bit. And the UE of the earlier release will then notice that the 5th bit is set and hence not consider this PRACH resource applicable for this UE. If the UE instead would have ignored the value of the 5th bit, the UE might have determined that the UE can use the PRACH resource, given that the bits that the UE did inspect were set for the features which the UE wanted to indicate, which would have been wrong.

An example implementation of the bitmap approach is shown below where the mapping is provided towards the end of the following ASN.1 section. It has been added a field “featureMapping” which is of the type BITSTRING of size 10. The field is optional allowing for that if the mapping is absent, the RACH resource is to be used when the UE does not want to indicate any of the features.

| | |
|---|---|
| 6.2.3.3 - | RACH-ConfigCommon |

The IE RACH-ConfigCommon is used to specify the cell specific random-access parameters.

RACH-ConfigCommon information element

-- ASN1START
-- TAG-RACH-CONFIGCOMMON-START

| RACH-ConfigCommon ::= | SEQUENCE { | |
|---|---|---|
| rach-ConfigGeneric | RACH-ConfigGeneric, | |
| totalNumberOfRA-Preambles | INTEGER (1..63) | OPTIONAL, -- Need S |

ssb-perRACH-OccasionAndCB-PreamblesPerSSB CHOICE {

| oneEighth | ENUMERATED {n4,n8,n12,n16,n20,n24,n28,n32,n36,n40,n44,n48,n52,n56,n60,n64}, | |
|---|---|---|
| oneFourth | ENUMERATED {n4,n8,n12,n16,n20,n24,n28,n32,n36,n40,n44,n48,n52,n56,n60,n64}, | |
| oneHalf | ENUMERATED {n4,n8,n12,n16,n20,n24,n28,n32,n36,n40,n44,n48,n52,n56,n60,n64}, | |
| one | ENUMERATED {n4,n8,n12,n16,n20,n24,n28,n32,n36,n40,n44,n48,n52,n56,n60,n64}, | |
| two | ENUMERATED {n4,n8,n12,n16,n20,n24,n28,n32}, | |
| four | INTEGER (1..16), | |
| eight | INTEGER (1..8), | |
| sixteen | INTEGER (1..4) | |
| } | | OPTIONAL, -- Need M |
| groupBconfigured | SEQUENCE { | |
| ra-Msg3SizeGroupA | ENUMERATED {b56, b144, b208, b256, b282, b480, b640, | |
| | b800, b1000, b72, spare6, spare5,spare4, spare3, spare2, spare1}, | |
| messagePowerOffsetGroupB | ENUMERATED { minusinfinity, dBO, dB5, dB8, dB10, dB12, dB15, dB18}, | |
| numberOfRA-PreamblesGroupA | INTEGER (1..64) | |
| } | | OPTIONAL, -- Need R |
| ra-ContentionResolutionTimer | ENUMERATED { sf8, sf16, sf24, sf32, sf40, sf48, sf56, sf64}, | |
| rsrp-ThresholdSSB | RSRP-Range | OPTIONAL, -- Need R |
| rsrp-ThresholdSSB-SUL | RSRP-Range | OPTIONAL, -- Cond SUL |

| | |
|---|---|
| prach-RootSequenceIndex | CHOICE { |
| I839 | INTEGER (0..837), |
| I139 | INTEGER (0..137) |

},

| msg1-SubcarrierSpacing | SubcarrierSpacing | OPTIONAL, -- Cond L139 |
|---|---|---|
| restrictedSetConfig | ENUMERATED {unrestrictedSet, restrictedSetTypeA, restrictedSetTypeB}, | |
| msg3-transformPrecoder | ENUMERATED {enabled} | OPTIONAL, -- Need R |

```
  ...,
  [[
  ra-PrioritizationForAccessIdentity-r16 SEQUENCE {
```

| | |
|---|---|
| ra-Prioritization-r16 | RA-Prioritization, |
| ra-PrioritizationForAl-r16 | BIT STRING (SIZE (2)) |

| | |
|---|---|
| } | OPTIONAL, -- Cond InitialBWP-Only |

| | |
|---|---|
| prach-RootSequenceIndex-r16 | CHOICE { |
| I571 | INTEGER (0..569), |
| I1151 | INTEGER (0..1149) |

```
  } OPTIONAL -- Need R
    ]],
    [[
```

| | | |
|---|---|---|
| featureMapping | BITSTRING (SIZE (10)) | OPTIONAL |

]]
}
-- TAG-RACH-CONFIGCOMMON-STOP
-- ASN1STOP

### 1.2.2 Approach with Set of Flags

In another embodiment, the mapping is signaled by a set of flags where each flag indicates whether the PRACH resource is associated to a certain feature. There may for example be four flags:
Flag for feature A
Flag for feature B
Flag for feature C
Flag for feature D

If a certain PRACH resource is to be mapped to feature A, the flag for feature A would be set.

If a certain PRACH resource is to be mapped to feature B, the flag for feature B would be set.

If a certain PRACH resource is to be mapped to feature A and feature B, the flag for feature A would be set and the flag for feature B would be set.

A drawback with this approach compared to the bitmap is that it is not futureproof. If the UE is of, say, Release 17 and in Release 18 it is added a new flag which corresponds to a Rel-18 feature then the UE may not comprehend or even realize the existence of a new flag. So even if the flag indicates that the RACH resource is applicable for the Rel-18 feature, the Rel-17 UE may, based on the Rel-17 and earlier flags, determine that the PRACH resources should be used by the UE. But that would not be correct since the UE has missed to consider the Rel-18 flag.

### 1.2.3 Inductive Approach

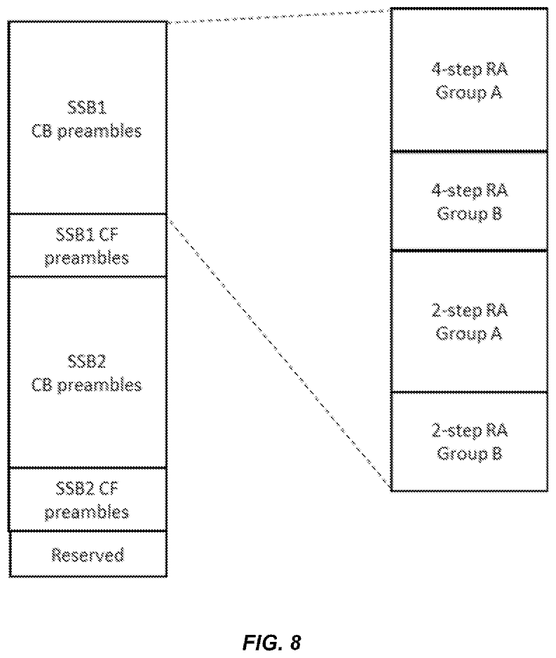

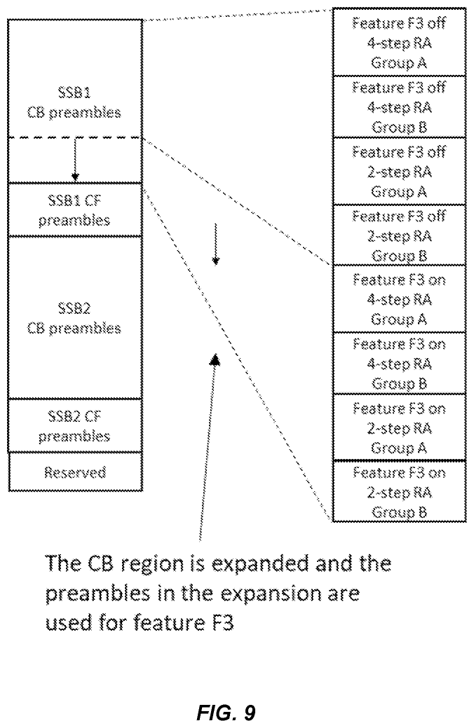

In another embodiment, the features to be signaled via PRACH have an assumed order, e.g. feature F1 comes before feature F2, which in turn comes before feature F3 etc. The partitioning is then performed in an inductive manner. The approach can be described as follows:
The PRACH configurations defined for Rel-15 4-step RA and Rel-16 2-step RA in PRACH-ConfigCommon and RACH-ConfigCommon2stepRA, respectively, are used as starting point. The group A/B feature in Rel-15 4-step RA can be seen as feature F1 and the 2-step RA feature introduced in Rel-16 can be seen as feature F2. Hence the next feature to be added is feature F3.
When a new feature Fn (e.g., F3=RedCap) to be signaled via PRACH is introduced, a new IE is added in system information which contains the PRACH configuration for the new feature. For example, a new RACH-configCommon-Fn IE could be added in SIB1 with similar content as the RACH-ConfigCommon and RACH-ConfigCommon2stepRA IEs. It is assumed here that feature Fn is a binary feature, i.e. it is either on or off, although the method can be extended to multiary features as well.
Feature Fn either defines new, separate PRACH occasions or shares PRACH occasions defined by one of the previously introduced features. In the latter case the RACH-configCommon-Fn IE can point to the PRACH occasions defined by the previously introduced feature. For example, if feature Fn shares PRACH occasions with feature F1 (the Rel-15 group A/B feature), the RACH-configCommon-Fn IE can point to PRACH occasions defined in the Rel-15 RACH-ConfigCommon IE rather than defining new, separate ones.
If separate PRACH occasions are defined, the SSB-associated contention-based preambles are partitioned to signal feature Fn combined with the other, previously introduced features. For example, if feature F3 is added and the two previously introduced features are F2 (2-step RA) and F1 (group A/B), four partitions would be needed (see FIG. 8):
   Feature F3 with 4-step RA
      Feature X with 4-step RA and group A (partition 00)
      Feature X with 4-step RA and group B (partition 01)
   Feature F3 with 2-step RA
      Feature X with 2-step RA and group A (partition 10)
      Feature X with 2-step RA and group B (partition 11)
Only feature combinations which are compatible with feature Fn need to be supported. If there are k other binary features that Fn can be combined with (and which also can be combined with each other), 2\hat{ }k partitions need to be defined to be able to signal every possible compatible combination rather than the maximum 2\hat{ }(n-1). Note that the amount of combinations may look daunting but in a real deployment only the combinations that are used would need to be signaled. For example, if 2-step RA is not used all the partitions (i.e., leaf nodes) under 2-step RA branch in the example above can be omitted.
If shared PRACH occasions are used, the SSB-associated contention-based preamble region is expanded and the preambles in the expansion are allocated to feature Fn. The feature Fn preambles can then be partitioned similar as in the non-shared case to signal feature Fn combined with the other, earlier introduced features (see FIG. 9). From the pre-Rel-17 UE's point of view the preambles allocated to feature X still looks like contention-free preambles which makes the solution backwards compatible. Note even though the expansion of the contention-based region may be preferable, it is not necessary for the method to work. The relation between the number of contention-based preambles and the number of contention-free preambles is always a tradeoff.

The overall preamble partitioning when feature F3 uses separate and shared PRACH occasions are illustrated in FIGS. 8 and 9, respectively. FIG. 8 illustrates an example of preamble partitioning when feature F3 uses separate PRACH occasions. FIG. 9 illustrates an example of preamble partitioning when feature F3 shares the PRACH occasions defined by the Rel-15 group A/B feature. Note that in FIG. 8 it is assumed that both feature F3 and F2 (2-step RA) share the PRACH occasions defined by feature F1 (group A/B). As can be seen from these figures using separate PRACH occasions for feature F3 saves one level of preamble partitioning since the partitions where feature F3 is off can be omitted. The price paid for the reduced level of preamble partitioning is the increased amount of PRACH occasions.

### 1.3 Multiple PRACH (Sub)Resource Having the Same Mapping

It may be so that multiple PRACH resources, or sub-resources, are mapped to the same set of features. An example configuration is as follows (the arrow means “maps to”):
PRACH resource X→Feature A+Feature C
Preamble set Y1 of PRACH resource Y→Feature A+Feature C
   In this example configuration, a UE which should perform random access and indicate both feature A and feature C has two possible PRACH resources available; both PRACH resource X (any preamble within that PRACH resource) and the preambles defined by set Y1 in PRACH resource Y.

Different selection mechanisms are possible for the UE to select which of the available resources are used as explained in the following subsections.

### 1.3.1 Randomized Selection

Per PRACH resource probability: The UE selects randomly which of the possible PRACH resources the UE should use. The randomization may be done so that the probability is equal among the possible PRACH resources (50% chance to select any of the two resources in case of the example above). When the UE has selected PRACH resource, the UE would proceed to select a preamble within the selected resource.

Weighted with number of preambles: Another possibility is that the randomization is done so that the probability to select a particular PRACH resource depends on the number of preambles in this PRACH (sub)resource and the total number of preambles in all PRACH (sub)resources. In our example above, there may be 64 preambles in PRACH resource X and 36 preambles in preamble set Y1 in PRACH resource Y, it would in this case be 64% probability to select PRACH resource X and 36% probability to select PRACH resource Y. This has the benefit compared the “Per PRACH resource probability”-approach, that the load will be shared between the resources dependent on the number of preambles that the resources have available. When the UE has selected PRACH resource the UE would proceed to select a preamble within the selected resource.

Per preamble probability: Another possibility which yields the same end result as the “Weighted with number of preambles”-approach is that the UE instead selects a particular preamble of all available preambles, and all preambles have equal probability to be selected. In our example above, there may be 64 preambles in PRACH resources X and 36 preambles in preamble set Y1 in PRACH resources Y, it would in this case be 1% probability to select any particular preamble.

Weighted with number of preambles and temporal proximity: For the purpose of PRACH resource selection, the UE assigns a weight to each “candidate” PRACH resource, where the weight is the sum of one weight based on the number of preambles available (for signaling of the UE's feature or feature combination) and another weight based on the time that remains until the PRACH resource. The UE then makes a weighted randomized selection between the “candidate” PRACH resources.

### 1.3.2 Next Possible

Another selection mechanism is that the UE selects the PRACH resource which occurs “next” in time. So, if the UE determines at time T that the UE shall perform a random access procedure and indicate Feature A and Feature C, the UE would use PRACH resource X if that resource is closest after the time T, otherwise the UE would use (preamble set Y1 within) PRACH resource Y.

### 2 Embodiment Group 2—RACH Occasion Mapping

In one embodiment, in order to simplify backwards compatibility, the Rel-16 PRACH is left untouched, and all legacy UEs plus Rel-17 UEs that have all the new features disabled will use this PRACH to initiate the random access procedure. A new PRACH is then defined to enable the early signaling of all the new features.

The overall structure of the PRACH slot and periodicity is defined in the same way as in legacy (its size in time (N_{T}) and frequency (N_{F})). On the other hand, the mapping between PRACH occasions and SSB is limited to the definition of the parameter N (number of SSBs per PRACH occasion) instead of the complex structure used in legacy that simultaneously defines the number of SSB per PRACH occasion and the number of contention based preambles per SSB. The value of these parameters should not be limited to the values used in legacy PRACH but might be extended.

As a consequence, a PRACH slot is obtained which is composed by a number of PRACH occasions (N_{RO}=N_{T}×N_{F}), each of them with an associated index (r), and where each of them can be mapped to several SSBs (if N>1), or where a set of N_{F} contiguous PRACH occasions is mapped to only one SSB (if N<1). Index r takes values from 0 to

$${N}_{T} \times {N}_{F} \times ⌈ \frac{1}{N} ⌉ - 1 ,$$

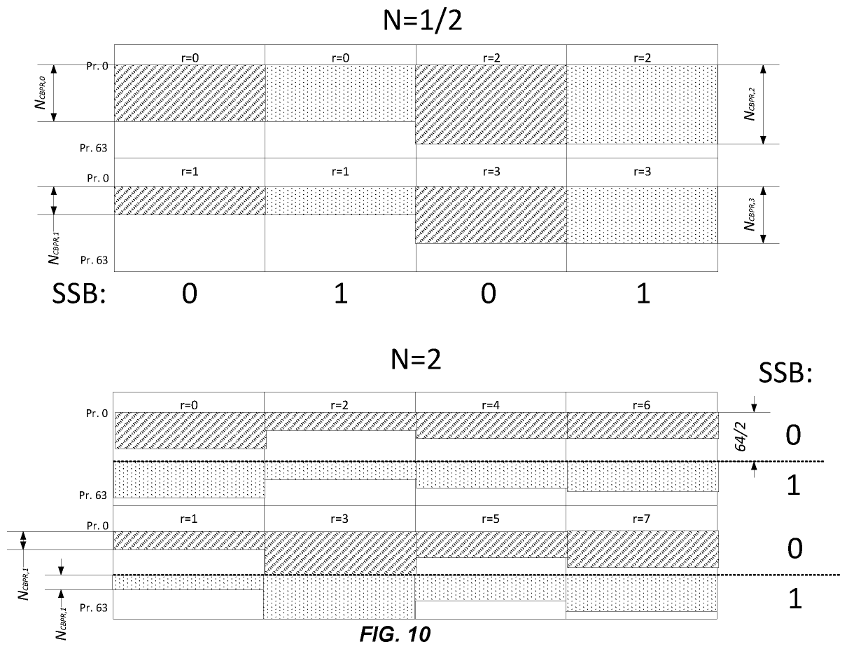

and although there might be PRACH Occasions with the same index, they are mapped to different SSBs, so that the combination r-SSB index is unique (see FIG. 10 for detail).

For each index r, it is defined a number of contention-based preambles (denoted as N_{CFPR,r} where r is the PRACH occasion index). This will be used later to tune the capacity based on the traffic present for a certain kind of feature combination and keep under control the gNB effort to detect preambles. FIG. 10 shows an example where a 4×2 PRACH slot is defined (8 PRACH occasions) and are mapped to 2 SSBs both by setting N=2 and N=1/2. In other words, FIG. 10 illustrates an example of 4×2 PRACH slot with 2 SSBs and both N<1 and N>1 cases. Rectangle with associated “r” is a RACH occasion, and diagonal/dotted hashed rectangles represent a set of preambles within each RACH occasion. In the first case, PRACH occasion indexes are repeated twice for a total of 4 amounts of CB preambles, and in the second case the indexes are not repeating and there are 8 amounts of contention-based preambles defined. In FIG. 10, the preamble space is represented as going from the top of a PRACH occasion to the bottom, a rectangle (with diagonal hashing or dot hashing) represent then a preamble segment.

Finally, a set of bitmaps are defined for each feature. Each bitmap has the same number of elements as there are distinct PRACH occasion indexes

$$( {N}_{T} \times {N}_{F} \times ⌈ \frac{1}{N} ⌉ ) .$$

Each bitmap indicates in which PRACH occasions a certain feature is enabled, as a consequence by combining all the bitmaps a UE knows which PRACH occasion to use in order to signal a certain feature combination.

Continuing the above example, if we assume the following bitmaps for the case of N=1/2:
featureA_bitmap: 1 1 0 0
featureB_bitmap: 0 0 1 0
featureC_bitmap: 0 1 1 1
   the UE can deduce that both PRACH occasions with index r=1 are to be used when both features A and C are enabled at the same time (the relevant bits in the bitmaps are highlighted). UE will use the first time slot if it is in SSB0, or the second time slot if it is in SSB1.

In the same way, for the case of N=2 and the following bitmaps:
featureA_bitmap: 1 1 1 1 0 0 0 0
featureB_bitmap: 1 1 0 0 1 1 0 0
featureC_bitmap: 1 0 1 0 1 0 1 1
   the two PRACH occasions with indexes r=6 and r=7 can be used when feature C only is enabled. Within each PRACH occasion there will be preambles for SSB0 and SSB1, the UE will select the appropriate set to be used based in which SSB it is located.

Notice that within each set of preambles associated with an SSB and contained to a PRACH occasion, there might be further subdivisions as in legacy PRACH resource structure, for example to enable Group A and Group B. To allow this a further set of parameters can be defined for the scope, in the same amount as the aforementioned N_{CBPR,r}. Similarly, it is possible to define contention-free preambles by adding one further set of parameters.

This embodiment can be considered backwards compatible if the same reasoning is continued in Rel-18: the Rel-16 and Rel-17 PRACH resources are used by all Rel-16/17 UEs and by Rel-18 UEs for which all the Rel-18 new features are disabled, and a new PRACH resources is defined for Rel-18 features and all necessary combinations with Rel-16/17 features.

### 3 Embodiment Group 3: Per Feature Configuration Pointing Out Associated PRACH Resource/Preamble Partition

The following terminology is defined for the purpose of the descriptions in this section:
PRACH Resource: A set of time/frequency transmission resources in the OFDM time/frequency grid, where this set of time/frequency transmission resources constitute one PRACH occasion.
PRACH Resources: Multiple sets of time/frequency transmission resources in the OFDM time/frequency grid, wherein each set of time/frequency transmission resources constitute one PRACH occasion.
PRACH Occasion: A set of time/frequency transmission resources in the OFDM time/frequency grid that a UE can use to transmit a random access preamble. If a PRACH occasion is defined by its slot number, set of symbol numbers within the slot and set of subcarriers (or PRBs) in the frequency domain, then each PRACH occasion is unique within its PRACH configuration period. However, a PRACH occasion with the same defining properties/parameters will recur in each PRACH configuration period. If the SSB index(es) that map(s) to the PRACH occasion is added to its defining properties/parameters, then each PRACH occasion is unique within its association period, but a PRACH occasion with the same defining properties/parameters will recur in each association period.
RACH Occasion (RO): This term is equivalent to the term “PRACH occasion”.
SSB to RO Mapping Cycle: A cycle of mapping of all the SSB indexes used in a cell to ROs in accordance with the SSB to PRACH occasion mapping configuration, e.g. determined by the ssb-perRACH-Occasion part of the ssb-perRACH-OccasionAndCB-PreamblesPerSSB parameter (or another parameter serving the same purpose of configuring the number of SSB indexes that map to a PRACH occasion) together with the SSB index to PRACH occasion mapping rule specified in 3GPP TS 38.213 and described above. During a single SSB to RO mapping cycle, each SSB index used in the cell is mapped only once (to one or more PRACH occasions). Equivalent terms are “SSB to PRACH occasion mapping cycle”, “SSB index to PRACH occasion mapping cycle”, “SSB to RACH occasion mapping cycle”, “SSB index to RACH occasion mapping cycle” and “SSB index to RO mapping cycle”.
Feature Association Cycle: A cyclically contiguously repeated time period in which all configured features that use RA Msg1 for feature signaling are associated with PRACH occasion(s) and preamble range(s) for all SSB indexes used in the cell. It is the smallest repetitive time period that can be formed such that it contains a pattern of feature to PRACH occasion and preamble range association(s) for all SSB indexes used in the cell that is repeated in every contiguously repeated period. That is, reducing the size of the period would result in the pattern of feature to PRACH occasion and preamble range association(s) would not be the same in each period. In addition, any larger repetitive time interval that would contain a pattern of feature to PRACH occasion and preamble range association(s) that would be repeated in each time interval would have to be an integer multiple of the feature association period. (“Feature association period” could maybe have been a slightly better term, but that would increase the risk of mix-up with the “association period” used in the context of SSB index to PRACH occasion mapping.)
Partitioning Set: A set of PRACH occasions which may be divided into partitions for feature signaling, wherein this set of PRACH occasions is repeated every feature association cycle. A typical example of a partitioning set is the set of PRACH occasions associated with the same SSB index (where the same partitioning would be used for the set of PRACH occasions associated with every SSB index). With this typical example, the partitioning set would recur with each SSB to RO mapping cycle and consequently a feature association cycle would be equally long as an SSB to RO mapping cycle. Terms that may be used to refer to the same concept as the “partitioning set” may be “partitioning space” or “partitioning unit”.

It should also be noted that the terms “preamble range”, “preamble subrange”, “range of preambles” and “subrange of preambles” are used herein as equivalent to the respective terms “preamble index range”, “preamble index subrange”, “range of preamble indexes” and “subrange of preamble indexes”.

It should in addition be noted that the term “SSB” is often used as equivalent to “SSB index” herein.

Furthermore, in the embodiment descriptions in this section, the expressions “the available preambles in a PRACH occasion”, “the number of available preambles in a PRACH occasion”, “the preambles available in a PRACH occasion” and “the number of preambles available in a PRACH occasion” should be interpreted as “the number of preambles available for feature signaling in a PRACH occasion”.

Moreover, expressions like “preamble in the PRACH occasion”, “preamble for the PRACH occasion”, “preamble associated with the PRACH occasion”, “preamble range in the PRACH occasion”, “preamble range for the PRACH occasion”, “preamble range associated with the PRACH occasion”, “preamble subrange in a PRACH occasion”, “preamble range pre-partition in a PRACH occasion”, “preambles available in a PRACH occasion”, “preamble range available in a PRACH occasion”, etc. mean that the preamble, preambles, preamble range, preamble subrange, preamble range pre-partition, etc. is/are configured for the PRACH occasion.

In addition, the terms “PRACH configuration period”, “association period” and “association pattern period” are relevant. These terms are described in the following excerpt from 3GPP TS 38.213:

### **********Start Excerpt from 3GPP TS 38.213*********

An association period, starting from frame 0, for mapping SS/PBCH block indexes to PRACH occasions is the smallest value in the set determined by the PRACH configuration period according Table 8.1-1 such that N_{Tx}^{SSB} SS/PBCH block indexes are mapped at least once to the PRACH occasions within the association period, where a UE obtains N_{Tx}^{SSB} from the value of ssb-PositionsInBurst in SIB1 or in ServingCellConfigCommon. If after an integer number of SS/PBCH block indexes to PRACH occasions mapping cycles within the association period there is a set of PRACH occasions or PRACH preambles that are not mapped to N_{Tx}^{SSB} SS/PBCH block indexes, no SS/PBCH block indexes are mapped to the set of PRACH occasions or PRACH preambles. An association pattern period includes one or more association periods and is determined so that a pattern between PRACH occasions and SS/PBCH block indexes repeats at most every 160 msec. PRACH occasions not associated with SS/PBCH block indexes after an integer number of association periods, if any, are not used for PRACH transmissions.

TABLE 8.1-1
Mapping between PRACH configuration period and SS/PBCH
block to PRACH occasion association period

| PRACH configuration period | Association period (number of |
|---|---|
| (msec) | PRACH configuration periods) |
| 10 | {1, 2, 4, 8, 16} |
| 20 | {1, 2, 4, 8} |
| 40 | {1, 2, 4} |
| 80 | {1, 2} |
| 160 | {1} |

*********End Excerpt from 3GPP TS 38.213*********

As can be seen from the above, a PRACH configuration period can be 10, 20, 40, 80 or 160 ms long. It is also defined by the parameter x in the random access configuration tables in 3GPP TS 38.211 (Table 6.3.3.2-2, Table 6.3.3.2-3 and Table 6.3.3.2-4), of which Table 6.3.3.2-2, which is applicable for FDD deployments in FR1, is recited above.

The overall concept of the embodiments in this embodiment group is that a common pool of PRACH occasions (each with a preamble range which may be partitioned if needed) dedicated for feature signaling is configured, and then each feature configuration points out the PRACH occasion(s), and preamble range when applicable, in this pool that are used for signaling of the feature. In other words, a single new separate RACH configuration is provided for configuration of PRACH occasions (including SSB to PRACH occasion mapping and preamble range configuration) which are used for signaling of features (wherein this RACH configuration may be referred to as “RACH configuration for feature signaling”). Then each feature that may be signaled has its own feature configuration, which contains indication(s) of which PRACH occasion(s) and/or which preamble range(s) (out of those configured by the RACH configuration for feature signaling) the feature is associated with.

In this context, that a PRACH occasion and/or a preamble range in a PRACH occasion, is associated with a feature means that if the UE uses this PRACH occasion when transmitting a random access preamble, this signals that the UE supports the feature and/or that the feature is active in the UE and/or that the UE wants to use the feature and/or that the UE requests special treatment or support from the network to enable the feature. Note that a PRACH occasion (including all its preambles), or a preamble range in a PRACH occasion, may be associated with more than one feature, in which case the PRACH occasion, or preamble range in the PRACH occasion, is used to signal the combination of the associated features.

To support feature signaling, there is thus a single RACH configuration and one or more feature configurations (one for each feature to be signaled).

To increase the signaling possibilities, i.e. the number of features and feature combinations that may be signaled, it may be preferable to “sacrifice” the use of the existing (optional) division of the preambles into group A and group B, as well as the use of two RA types (4-step RA and 2-step RA) in the same PRACH occasion, at least when the number of features and feature combinations to be signaled grows. Preamble groups A and B may be easy to sacrifice, since when the PRACH occasion/preamble indicates a feature or feature combination to the network, the network may want to use this information to adapt the PUSCH transmission resource allocation for Msg3, rather than basing it on the preamble group of the received preamble. When it comes to choice the single RA type to configure for use in the PRACH occasions configured by the RACH configuration for feature signaling, the preferable choice may be 4-step RA, because it is more resource efficient than 2-step RA, which comes with the cost of pre-allocated MsgA PUSCH transmission resources.

These “sacrifices” should however be seen as options (albeit maybe preferable) and are not mandated. If preamble groups A and B, and/or dual RA types are configured for the PRACH occasions for feature signaling, then any division into subranges of the preamble range for the purpose of feature signaling would have to be repeated per preamble group, or per RA type or per RA type-preamble group combination.

Another way to support both RA types together with feature signaling could be to provide two instances of RACH configuration for feature signaling, where one of them configures PRACH occasions for 4-step RA and one of them configures PRACH occasions for 2-step RA. The feature configuration for a feature for which 2-step RA is suitable could then point out PRACH occasions for which 2-step RA is configured, while the feature configuration for a feature for which 4-step RA is suitable could point out PRACH occasions for which 4-step RA is configured. As another option, a feature configuration could point out both PRACH occasions with 2-step RA and PRACH occasions with 4-step RA and let the selection between them be governed by an RSRP threshold or some other condition. A similar approach could be used to realize the effect of preamble groups A and B, by letting one instance of RACH configuration for feature signaling configures PRACH occasions for which all preambles are assumed to be group A preambles, while a second instance of RACH configuration for feature signaling configures PRACH occasions for which all preambles are assumed to be group B preambles. The principle can be extended to combinations of RA types and preamble groups.

Furthermore, there is no need for CFRA preambles in PRACH occasions for feature signaling, since CFRA preambles are used by UE's in RRC_CONNECTED state and then the network is already aware of the UE's features and no feature signaling is needed. Random access preambles may also be used for request of on-demand system information (SI), but for system information request, UEs can use the “regular” PRACH occasions which are not configured for feature signaling. Hence, if the preambles are not divided into group A and group B and only one RA type is configured and no preambles are set aside as CFRA preambles or preambles for SI request, then all 64 preambles may be available for feature signaling in the PRACH occasions configured for feature signaling.

In the continued descriptions of embodiments in this embodiment group, it is assumed that this is the case (and that the configured RA type is 4-step RA), but as previously explained, the mechanisms can still be applied even if preamble division is used for group A and B and/or for RA types. For simplicity, it is further assumed that each SSB maps to one or more PRACH occasion and the case where multiple SSBs map to the same PRACH occasion is excluded. This is however purely for the purpose of simplifying the description, and the embodiments can easily be generalized to the case where multiple SSBs map to the same PRACH occasion. In that case the preamble subrange associated with each of the multiple SSBs would be further subdivided to support signaling of more than one feature. And even if it is preferable to not set aside any preambles for CFRA and/or SI request in PRACH occasions for feature signaling, the solutions and mechanisms of the embodiments described herein are in no way dependent on this to work. If some preambles are set aside for CFRA and/or SI request, this only means that the number of preambles available for feature signaling decreases, but the principles of the solution are unaffected.

### 3.1 Embodiments with PRACH Occasion and Preamble Range Association Solely Governed by the Feature Configurations

In these embodiments, an IE similar to the RACH-ConfigCommon IE (or similar to the RACH-ConfigCommonTwoStepRA-r16 IE if 2-step RA is configured instead of 4-step RA) is introduced for RACH configuration for feature signaling, e.g. denoted as “RACH-ConfigCommonFeatureSignaling”. The RACH-ConfigCommonFeatureSignaling IE is signaled in the same way as the RACH-ConfigCommon IE, i.e. in the system information, but also in dedicated signaling in some situations.

To enable a feature configuration to point at a PRACH occasion configured by the RACH-ConfigCommonFeatureSignaling IE, the PRACH occasions associated with the same SSB are numbered, or indexed, e.g. 0, 1, 2 . . . . To clarify which set of PRACH occasions the indexing is applied to and limited to, the notion of the number of SSBs per PRACH occasion in the SSB to RO mapping is useful. For example, if the number of SSBs per PRACH occasion, e.g. the ssb-perRACH-Occasion part of the ssb-perRACH-OccasionAndCB-PreamblesPerSSB parameter, is “oneEight”, this means that 8 PRACH occasions are associated with the SSB index and hence these 8 PRACH occasions are indexed 0, 1, 2, 3, 4, 5, 6, 7. After an SSB to RO mapping cycle, this set of PRACH occasions will be repeated (again associated with the same SSB index) and will then again be indexed 0, 1, 2, 3, 4, 5, 6, 7. The association of features to PRACH occasions considers only one such set of PRACH occasions.

As a non-limiting example, the PRACH occasion indexing (of PRACH occasions associated with the same SSB) could be done in the following order:
first in increasing order of frequency resource indexes for frequency multiplexed PRACH occasions,
second, in increasing order of time resource indexes for time multiplexed PRACH occasions within a PRACH slot, and
third, in increasing order of indexes for PRACH slots.

Note that the same indexing is done for the PRACH occasion sets associated with each SSB index (and in addition, as described above, the indexing is repeated once every SSB to RO mapping cycle, when the SSB to PRACH occasion mapping recurs for the same SSB index).

Then a feature configuration (e.g., a “FeatureX-Config” IE) could indicate the index(es) of the PRACH occasion(s) the feature is associated with. This may for example be done by a sequence of index(es) (e.g., integers), or a bitmap, where each bit represents one of the PRACH occasions (associated with the same SSB) and a bit set to 1 (for example) could indicate that the feature is associated with it for feature signaling. (With this principle where the PRACH occasions associated with the same SSB index are partitioned for signaling of different features is in line with a “feature association cycle” that has a length that is equal to the length of an “SSB to RO mapping cycle”.)

Furthermore, if one of the indicated PRACH occasions is to be used for feature signaling by one or more other feature(s) too, the features associated with the same PRACH occasion have to use different partitions of the available preamble range. To this end, a feature configuration (e.g., a “FeatureX-Config” IE) could indicate a preamble range (which should be a subrange of the total available preamble range in the PRACH occasion) the feature is associated with. As one option, a single such preamble range indication could be provided to be valid in all PRACH occasion(s) the feature is associated. However, a feature may have different sharing relations in different ones of its associated PRACH occasions. For instance, in one of the associated PRACH occasions the UE may share the PRACH occasion with one other feature, while in another associated PRACH occasion the UE may share the PRACH occasion with two other features, while in yet another associated PRACH occasion no other feature shares the PRACH occasion with the UE. To support such diverse and flexible scenarios, another option is to let the feature configuration indicate a separate preamble range for each associated PRACH occasion. These two options could also be combined such that if the feature can advantageously use the same preamble range in all its associated PRACH occasions, it suffices to include a single preamble range indication which is valid in all associated PRACH occasions, whereas in cases where this would be suboptimal, the feature configuration instead includes a preamble range indication per associated PRACH occasion. Absence of a preamble range indication could indicate association with the entire available preamble range in the PRACH occasion, e.g. 64 preambles.

A preamble range indication could for instance consist of a start preamble index and an end preamble index, or, alternatively, a start preamble index and an indication of the number of preambles in the range.

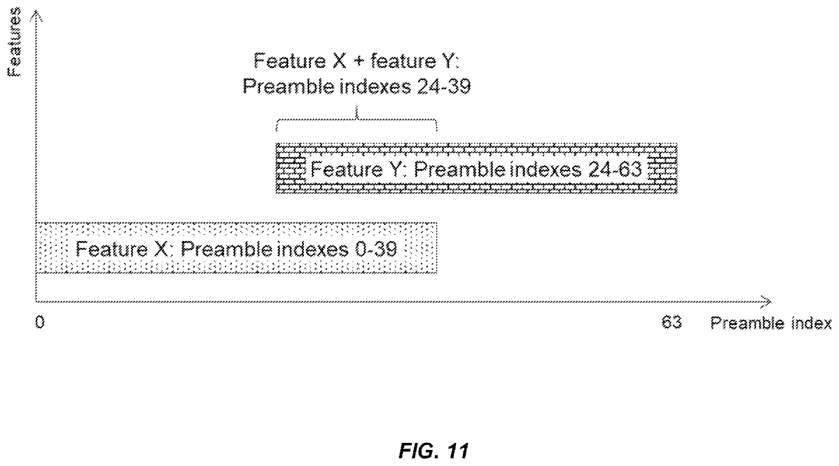

A further complication arises when features sharing a PRACH occasion are not only to be signaled separately, but the combination of features should also be possible to signal. Configuration-wise, this may be achieved by indicating overlapping preamble ranges associated with two (or more) features. For instance, if feature X and feature Y share a PRACH occasion (i.e., have an associated PRACH occasion in common), then feature X could indicate preamble index range 0-39, while feature Y indicates preamble index range 24-63. Then preamble indexes 0-23 would be used to signal feature X, preamble indexes 40-63 would be used to signal feature Y, while preamble indexes 24-39 would be used to indicate the combination of feature X and feature Y. This is illustrated in FIG. 11. FIG. 11 is an illustration of preamble index ranges associated with two different features, where the overlap between the preamble ranges enables signaling of the combination of the features.

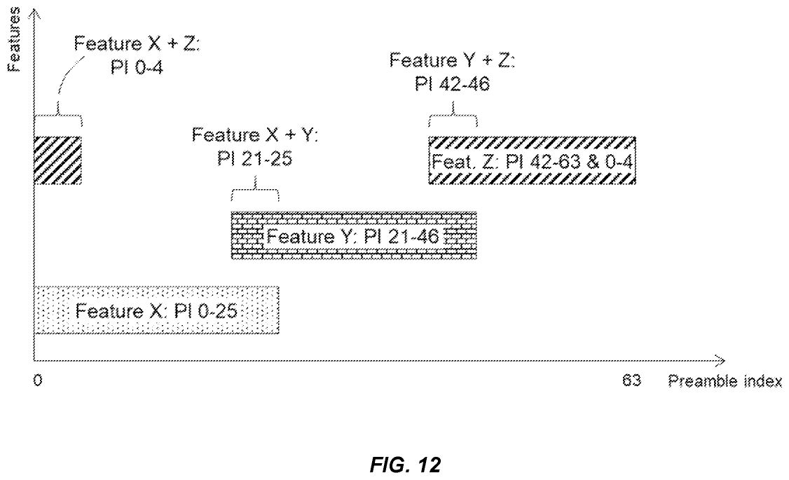

In a further, more complicated example, three features share a common PRACH resource and all combinations of two features should be possible to signal (as well as each single feature). This cannot be achieved without using discontinuous preamble ranges associated with at least one of the features. This is illustrated in FIG. 12. FIG. 12 is an illustration of preamble index ranges associated with three different features and the overlaps between them that enables signaling of combinations of any two features.

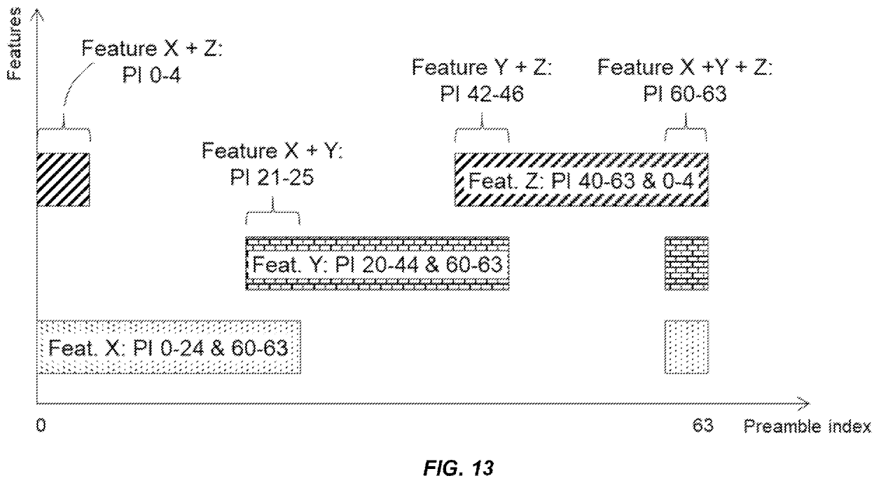

In a further, even more complicated example, three features share a common PRACH resource and all possible feature combinations (i.e., even the combination of all three features) should be possible to signal. How this can be achieved is indicated in FIG. 13. FIG. 13 is an illustration of preamble index ranges associated with three different features and the overlaps between them that enables signaling of combinations of any two features as well as the combination of all the three features.

When the preamble ranges associated with different features become increasingly fragmented as a consequence of a larger number of feature combinations to be possible to signal, another representation of the preamble ranges than the previous examples (i.e., start/stop preamble indexes, or start preamble index plus number of preambles). For instance, a bitmap could be used in the feature configuration, where each bit could represent a preamble index available in the cell and if a bit is set to 1, this would indicate that the corresponding preamble can be used to signal the feature. However, this would potentially amount to undesirably large data volumes, e.g. if each associated PRACH occasion should be accompanied by a 64 bits long bitmap in the feature configuration to indicate the preambles associated with the feature. To mitigate the growth of the configuration data, each bit in the bitmap could instead represent multiple preamble indexes, e.g. 2, 3, 4 or 8. This would limit the flexibility somewhat, but as long as not extremely complex (and many) feature combination cases should be possible to signal, association of pairs or groups of consecutive preamble indexes should serve well to indicate combination cases of low to medium complexity with moderate configuration data volumes.

As a further option, the number of preambles indexes each bit in the bitmap represents could be made flexible, so that it can be adapted to the requirements of the situation in terms of the number of features that are associated with the same PRACH occasion and the number of feature combinations (and the numbers of features in each combination) that should be possible to signal. For instance, if each bit in the bitmap represents N preamble indexes, the value of N could be indicated in the RACH-ConfigCommonFeatureSignaling IE, either one N value for each PRACH occasion (e.g., each PRACH occasion in a PRACH configuration period) or one N value that is valid for all PRACH occasions. As another option, the value of N may be derived from the number of features sharing a PRACH occasion according to a specified rule. The size of the bitmap should then preferably also be flexible, such that it contains no more bits than required to represent the entire available preamble range in the PRACH occasion, e.g. 64. That is, N×nbits=npreambles, where nbits is the number of bits in the bitmap and npreambles is the number of available preambles in the PRACH occasion. This relation also allows the value of N to alternatively be implicitly derived from the number of bits in the bitmap, i.e. N=npreambles/nbits. For instance, if a bitmap of 16 bits is signaled in a feature configuration for an associated PRACH occasion with 64 available preambles, N=64/16=4, meaning that each bit in the bitmap represents 4 consecutive preamble indexes.

Apparently, the complexity and potential configuration signaling overhead increases quickly when the number of features and feature combinations to be possible to signal in the same PRACH occasion increases, especially when combinations or more than two or three features are to be possible to signal. Hence, to limit the complexity and configuration signaling overhead, it may be preferable to restrict the number of features of a feature combination to be signaled and maybe also restrict the number of features that may share a common PRACH occasion (i.e., be associated with the same PRACH occasion). For instance, it could be allowed for up to three or four features to share a common associated PRACH occasion, and signaled feature combinations could be restricted to contain no more than two or three features. Such restrictions may be specified or simply enforced by operator choice when the network is configured.

### 3.2 Embodiments where the Feature to PRACH Occasion and/or Preamble Range is Aided and Restricted by the RACH Configuration for Feature Signaling

In these embodiments, the RACH configuration for feature signaling, e.g. the RACH-ConfigCommonFeatureSignaling IE, “prepares” the configured PRACH occasions and/or the available preamble ranges in the PRACH occasions to simplify the association indications from the feature configurations. As a consequence, the flexibility in the associations that may be indicated is also somewhat restricted.

The “preparation means” used in the RACH configuration for feature signaling is pre-partitioning of the available preamble range and/or the configured PRACH occasions. The feature configuration then indicates association with the prepared pre-partitions rather than freely indicating which PRACH occasions and/or preamble ranges they are associated with. To support the association indication from the feature configurations, the pre-partitions may be indexed or, alternatively, may be represented by bitmaps.

In one embodiment, the RACH configuration for feature signaling, e.g. the RACH-ConfigCommonFeatureSignaling IE, configures pre-partitions for the preamble range available in the PRACH occasions. This means that the available preamble range, e.g. consisting of 64 preambles, is divided into subranges, where each subrange is a pre-partition, e.g. 8 pre-partitions with 8 preambles (with 8 consecutive preamble indexes). In ASN.1 code, this could be captured in a simple INTEGER parameter:

```
RACH-ConfigCommonFeatureSignaling ::= SEQUENCE {
    :
    :
    :
  preamblePre-partitionSize INTEGER (2..32)
}
```

In another example, the parameter is instead of ENUMERATED type:

```
RACH-ConfigCommonFeatureSignaling ::= SEQUENCE {
    :
    :
    :
  preamblePre-partitionSize ENUMERATED {two, four, eight,
  sixteen, thirty-
two, spare3, spare2, spare1}
}
```

Or combined with a configuration the available preambles:

| | |
|---|---|
| RACH-ConfigCommonFeatureSignaling ::= | SEQUENCE { |

```
    :
    :
    :
```

| | |
|---|---|
| totalNumberOfRA-Preambles | INTEGER (1..63) DEFAULT 64, |
| preamblePre-partitionSize | INTEGER (2..32) |

}

Or:

| | |
|---|---|
| RACH-ConfigCommonFeatureSignaling ::= | SEQUENCE { |

```
    :
    :
    :
```

| | |
|---|---|
| totalNumberOfRA-Preambles | INTEGER (1..63) DEFAULT 64, |
| preamblePre-partitionSize | ENUMERATED {two, four, eight, sixteen, thirty- |

two, spare3, spare2, spare1}
}

A feature configurations would then refer to the preamble pre-partition(s) it is associated, e.g. using a sequence of pre-partition indexes or a bitmap where each bit represents a preamble pre-partition and a bit set to 1 means that the feature is associated with the corresponding preamble pre-partition. The PRACH occasions are not pre-partitioned in this embodiment and hence the PRACH occasion(s) a feature is associated with is indicated in the feature configuration as described in section 6.4.1. An alternative to dynamic configuration of the preamble pre-partition size is that it is specified in the standard.

Another option is to configure (or specify) preamble pre-partitions of unequal sizes. For instance, with 64 available preambles, there could be 4 pre-partitions of 8 preambles each and 2 pre-partitions with 16 preambles each. In ASN.1 code, this example could, e.g., be captured as follows:

| | |
|---|---|
| RACH-ConfigCommonFeatureSignaling ::= | SEQUENCE { |

```
    :
    :
    :
```

| | |
|---|---|
| preamblePre-partitionList | SEQUENCE (SIZE (1..maxNoOfPreamblePre- |

partitions)) OF PreamblePre-partitionConfig,
}

| | |
|---|---|
| PreamblePre-partitionConfig ::= | SEQUENCE { |
| preamblePre-partitionSize | INTEGER (2..32), |
| numberOfConsecutivePre-partitionsOfThisSize | INTEGER (1..32) |

}

Or:

| | |
|---|---|
| RACH-ConfigCommonFeatureSignaling ::= | SEQUENCE { |

```
    :
    :
    :
```

| | |
|---|---|
| preamblePre-partitionList | SEQUENCE (SIZE (1..maxNoOfPreamblePre- |

partitions)) OF PreamblePre-partitionConfig,
}

| | |
|---|---|
| PreamblePre-partitionConfig ::= | SEQUENCE { |
| preamblePre-partitionSize | ENUMERATED {two, four, eight, sixteen, thirty- |

two, spare3, spare2, spare1},

| | |
|---|---|
| numberOfConsecutivePre-partitionsOfThisSize | INTEGER (1..32) |

}

To make a configuration of preamble pre-partitions of unequal sizes more compact, a table with different preamble pre-partition combinations (one combination in each table row) could be specified, and then the configuration in the RACH configuration for feature signaling, e.g. the RACH-ConfigCommonFeatureSignaling IE, could be a simple INTEGER pointing at a row in the specified table, e.g.:

| | |
|---|---|
| RACH-ConfigCommonFeatureSignaling ::= | SEQUENCE { |

```
    :
    :
    :
```

| | |
|---|---|
| preamblePre-partitionCombinationIndex | INTEGER (2..32) |

}

Yet another alternative could be that the preamble pre-partitions (of equal or unequal sizes) are predetermined through standard specification (i.e., hardcoded in the standard).

In another embodiment, the RACH configuration for feature signaling, e.g. the RACH-ConfigCommonFeatureSignaling IE, configures pre-partitions for the PRACH occasions, e.g. among the PRACH occasions associated with the same SSB index. This means that the PRACH occasions associated with the same SSB index are divided into groups, where each group constitute one PRACH occasion pre-partition.

Generally, if N PRACH occasions are associated with the same SSB index, they could be pre-partitioned into M pre-partitions, where 1≤M≤N. For instance, with 8 PRACH occasions associated with the same SSB index, they could be pre-partitioned into 4 pre-partitions with 2 PRACH occasions in each pre-partition. Or, as another example, the PRACH occasion pre-partitions may have unequal sizes, e.g. if 8 PRACH occasions are associated with the same SSB index, they could be pre-partitioned into two pre-partitions with 3 PRACH occasions in each, and one pre-partition with 2 PRACH occasions.

When referring to PRACH occasion pre-partitions to indicate which one a feature is associated with, a feature configuration could, e.g., use pre-partition index(es) (wherein the PRACH occasion pre-partitions are indexed according to a specified rule) or a bitmap where each bit represents a PRACH occasion pre-partition and a bit set to 1 indicates that the feature is associated with the corresponding PRACH pre-partition.

In yet another embodiment, the RACH configuration for feature signaling, e.g. the RACH-ConfigCommonFeatureSignaling IE, configures pre-partitions both for the PRACH occasions, e.g. the among the PRACH occasions associated with the same SSB index, and for the preamble range available in the PRACH occasions. The pre-partition configuration as well as how the pre-partitions are referenced from feature configurations could be the same as described above in the previous two embodiments.

### 3.3 Embodiments where the Feature to Preamble Range Association is Governed by a Specified Rule

In these embodiments, a feature's association with one or more preamble range(s) is not explicitly configured in the feature configuration. Instead, these associations can unambiguously be derived based on a rule specified in a standard specification (i.e., predetermined rules).

The input data to the rule consists of the number of features sharing a PRACH occasion and the number of preambles available in the PRACH occasion. In addition, the order in which the features are configured is significant for the outcome of the rule.

The rule may output preamble partitions (i.e., preamble index subranges) for a PRACH occasion, including the sizes of the partitions and which feature(s) that is/are associated with each partition.

As one example embodiment, with input data being that 64 preambles are available in the PRACH occasion, and feature X and feature Y (configured in that order) share the PRACH occasion (i.e., are both associated with the PRACH occasion).

In this example embodiment, the rule then says that there are the following three preamble range partitions and feature associations:
Partition 1: Preamble index 0-23, associated with feature X;
Partition 2: Preamble index 24-47, associated with feature Y;
Partition 3: Preamble index 48-63, associated with both feature X and feature Y, i.e. the partition is used for signaling of the combination of feature X and Y.

In another example embodiment with the same input data, the rule says that there are the following two preamble range partitions and feature associations:
Partition 1: Preamble index 0-39, associated with feature X;
Partition 2: Preamble index 24-64, associated with feature Y.

Note that the two preamble range partitions overlap and consequently, the overlapping preamble indexes 24-39 are associated with both feature X and feature Y and are thus used to signal the combination of feature X and Y.

In another example embodiment, the input data is that 64 preambles are available in the PRACH occasion, and feature X, feature Y and feature Z (configured in that order) share the PRACH occasion (i.e., are all associated with the PRACH occasion). In addition, signaling of feature combinations is limited to combinations of two features.

In this example embodiment, the rule then says that there are the following six preamble range partitions and feature associations:
Partition 1: Preamble index 0-15, associated with feature X;
Partition 2: Preamble index 16-31, associated with feature Y;
Partition 3: Preamble index 32-47, associated with feature Z;
Partition 4: Preamble index 48-52, associated with both feature X and feature Y, i.e. the partition is used for signaling of the combination of feature X and Y;
Partition 5: Preamble index 53-57, associated with both feature X and feature Z, i.e. the partition is used for signaling of the combination of feature X and Z;
Partition 6: Preamble index 58-63, associated with both feature Y and feature Z, i.e. the partition is used for signaling of the combination of feature Y and Z.

In another example embodiment with the same input data (and restriction to signaling of combinations of two features), the rule says that there are the following two preamble range partitions and feature associations:
Partition 1: Preamble index 0-25, associated with feature X;
Partition 2: Preamble index 21-46, associated with feature Y;
Partition 3: Preamble index 42-63 and 0-4, associated with feature Z.
   Note that the preamble range partitions for feature X and Y overlap on preamble indexes 21-25. These preamble indexes are hence used for signaling of the combination of feature X and Y. Similarly, the preamble range partitions for feature Y and Z overlap on preamble indexes 42-46. These preamble indexes are hence used for signaling of the combination of feature Y and Z. Furthermore, the preamble range partitions for feature X and Z overlap on preamble indexes 0-4. These preamble indexes are hence used for signaling of the combination of feature X and Z.

In another example embodiment, the input data is that 64 preambles are available in the PRACH occasion, and feature X, feature Y and feature Z (configured in that order) share the PRACH occasion (i.e., are all associated with the PRACH occasion). In addition, signaling of all feature combinations (i.e., even the combination of all three features) should be supported.

In this example embodiment, the rule then says that there are the following seven preamble range partitions and feature associations:
Partition 1: Preamble index 0-14, associated with feature X;
Partition 2: Preamble index 15-29, associated with feature Y;
Partition 3: Preamble index 30-44, associated with feature Z;
Partition 4: Preamble index 45-49, associated with feature X and feature Y, i.e. the partition is used for signaling of the combination of feature X and Y;
Partition 5: Preamble index 50-54, associated with feature X and feature Z, i.e. the partition is used for signaling of the combination of feature X and Z;
Partition 6: Preamble index 55-59, associated with feature Y and feature Z, i.e. the partition is used for signaling of the combination of feature Y and Z;
Partition 7: Preamble index 60-63, associated with feature X, feature Y and feature Z, i.e. the partition is used for signaling of the combination of feature X, Y and Z.

In another example embodiment with the same input data (with signaling of all feature combinations supported), the rule says that there are the following three preamble range partitions and feature associations:
Partition 1: Preamble index 0-24 and 60-63, associated with feature X;
Partition 2: Preamble index 20-44 and 60-63, associated with feature Y;
Partition 3: Preamble index 40-63 and 0-4, associated with feature Z;
   Note that the preamble range partitions for feature X and Y overlap on preamble indexes 20-24. These preamble indexes are hence used for signaling of the combination of feature X and Y. Similarly, the preamble range partitions for feature Y and Z overlap on preamble indexes 40-44. These preamble indexes are hence used for signaling of the combination of feature Y and Z. Furthermore, the preamble range partitions for feature X and Z overlap on preamble indexes 0-4. These preamble indexes are hence used for signaling of the combination of feature X and Z. In addition, the preamble range partitions of all three features overlap on preamble indexes 60-63. These preamble indexes are hence used for signaling of the combination of feature X, Y and Z.

The above embodiments and the rules they comprise are non-limiting examples and other rules for partitioning of the preamble index range of a PRACH occasion as well as association of features and preamble index range partitions are conceivable without deviating from the above described principle of rule based preamble index range partitioning and feature association.

Typically, but not necessarily, the rule would produce smaller pre-partitions for signaling for feature combinations than for individual features and smaller pre-partitions the larger the number of features in the feature combinations. This reflects the assumption that, typically, signaling of a single feature will be more frequent than signaling of any feature combination, and the larger the number of combined features, the less frequent will the need to signal the combination be.

### 3.4 Extensions of the PRACH Occasion Partitioning Possibilities

In 3GPP release 16, the maximum number of PRACH occasions that may be associated with the same SSB index is 8 (corresponding to the value “oneEighth” of the ssb-perRACH-Occasion part of the ssb-perRACH-OccasionAndCB-PreamblesPerSSB IE in in the RACH-ConfigCommon IE or the value “oneEighth” of the msgA-SSB-PerRACH-Occasion part of the msgA-SSB-PerRACH-OccasionAndCB-PreamblesPerSSB-r16 IE in the RACH-ConfigCommonTwoStepRA-r16 IE).

If many features, e.g. additional future (today non-existing) features, that require feature signaling with Msg1, there will be a need for many signaling possibilities, including signaling of the separate features and various combinations of features. Then the maximum eight PRACH occasions associated with one SSB may not be enough, or suitable, to allow the fragmented partitioning that may arise. If more partitioning possibilities, e.g. a larger “partitioning space” or “partitioning set”, is required, or desired, one possibility is to increase the number of PRACH occasions that may be associated with the same SSB index. For instance, the current set of values for the ssb-perRACH-Occasion part of the ssb-perRACH-OccasionAndCB-PreamblesPerSSB IE (or some equivalent IE) could be complemented to include smaller values, e.g. 1/16 (“oneSixteenth”), 1/32 (“oneThirtytwoth”) (and maybe intermediate values like 1/10 (“oneTenth”), 1/12 (“oneTwelveth”), 1/14 (“oneFourteenth”), 1/20 (“oneTwentieth”), 1/24 (“oneTwentyfourth”), 1/28 (“oneTwentyeighth”)). As an example, doubling a partitioning set from 8 PRACH occasions associated with one SSB index (i.e., the ssb-perRACH-Occasion part of the ssb-perRACH-OccasionAndCB-PreamblesPerSSB IE set to “oneEighth”) to 16 PRACH occasions associated with one SSB index (i.e., the ssb-perRACH-Occasion part of the ssb-perRACH-OccasionAndCB-PreamblesPerSSB IE set to “oneSixteenth”) would allow twice as many features to be signaled without increasing the number of features sharing the same PRACH occasion. As a consequence, unless the number of frequency multiplexed PRACH occasions is increased, the length of the SSB to RO mapping cycle would also double.

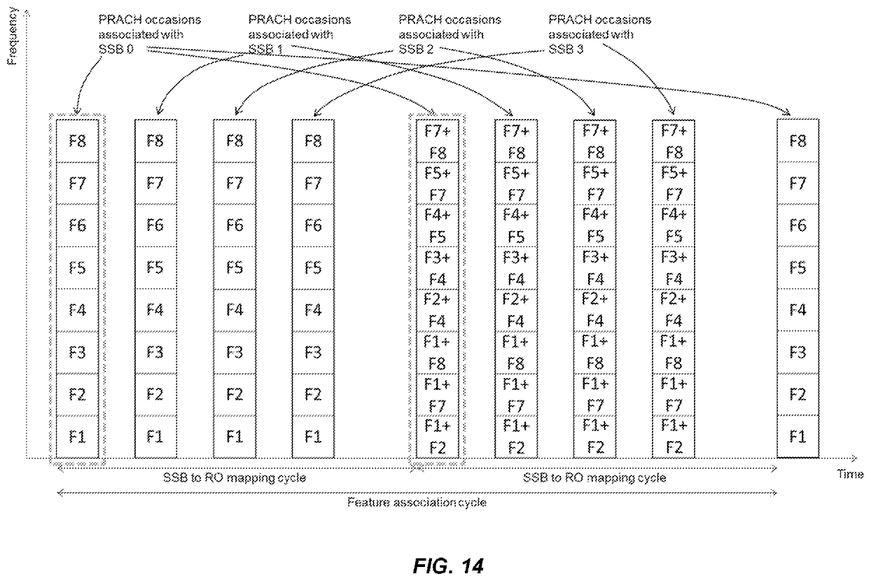

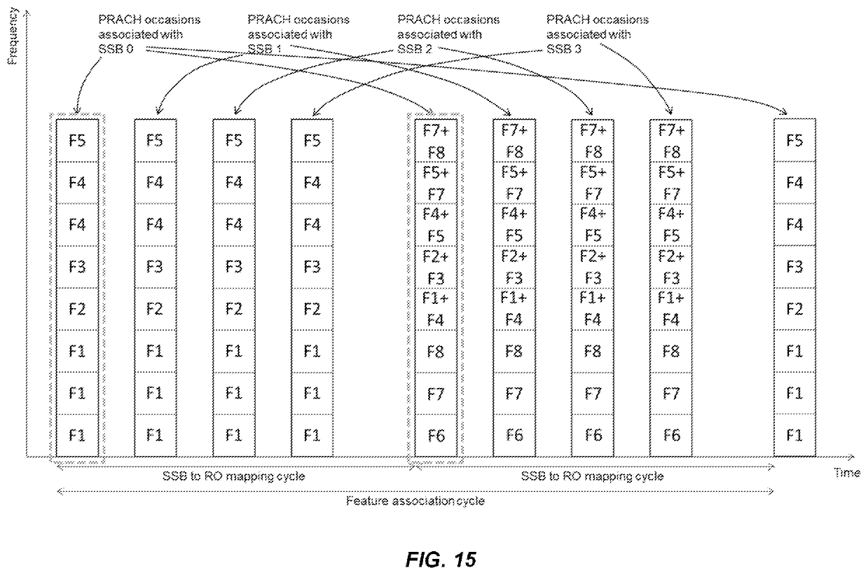

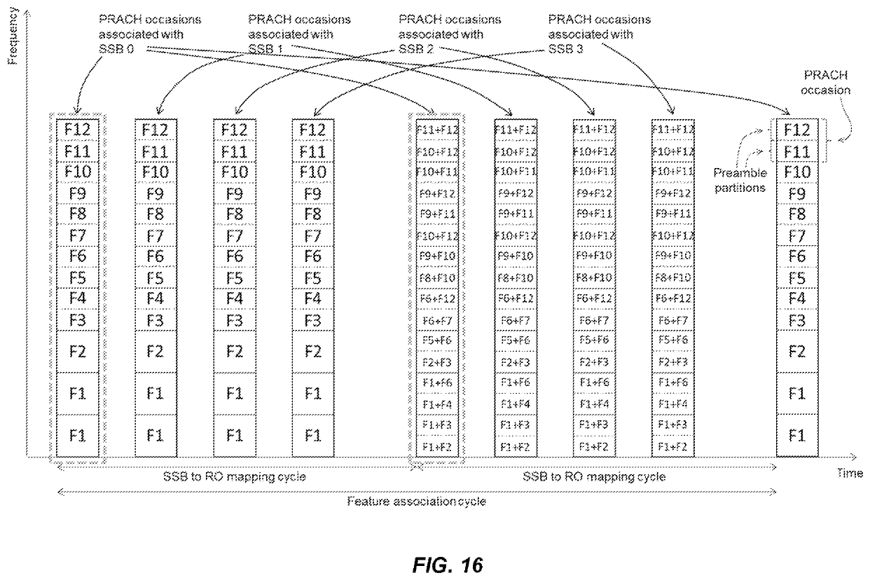

Another way to increase the “partitioning space” could be to let the set of PRACH occasions that are partitioned span across more than one “instance” of the SSB with the same index. In the description above, the set of PRACH occasions that is subject to partitioning and division between features for feature signaling, e.g. called a “partitioning set” or a “partitioning unit”, consists of the PRACH occasion(s) associated with one mapping of an SSB index, and this partitioning set would then recur for each instance of the same set of PRACH occasions mapped to the same SSB index (and the same partitioning would be done for the PRACH occasions associated with other SSB indexes too). When the partitioning set instead spans across more than one instance (i.e., more than one occurrence) of the set of PRACH occasions associated with the same SSB index. That is, if, for instance, the partitioning set spans two instances of the SSB with a certain index, e.g. SSB index 0, this means that one occurrence of the PRACH occasions associated with SSB index 0 together with the next occurrence of PRACH occasions associated with SSB index 0 are viewed as an enlarged partitioning unit, i.e. a group of PRACH occasions (containing two sets of the PRACH occasions associated with the same SSB index, e.g. SSB index 0) that can be partitioned and divided among different features for feature signaling. Another way to express this is that the PRACH occasions mapped to the same SSB index during two consecutive SSB to PRACH occasion mapping cycles are grouped together for partitioning. That is, the feature association cycle is twice as long as the SSB to PRACH occasion mapping cycle. This concept can of course be generalized to more than two SSB to PRACH occasion mapping cycles, e.g. three, four or more SSB to PRACH occasion mapping cycles (e.g., with a feature association cycle equal to N SSB to PRACH occasion mapping cycles). The concept is illustrated in FIG. 14, FIG. 15, and FIG. 16.

FIG. 14 is an illustration of an example of PRACH occasion partitioning and feature association when the feature association cycle spans two SSB to PRACH occasion mapping cycles. Four SSBs (with indexes 0-3) and eight features (F1-F8) are used in the example and each SSB index maps to eight frequency multiplexed PRACH occasions. The PRACH occasions that constitute one partitioning set are framed with thick, grey, dashed frames. Feature combinations that may be signaled are limited to combinations of two features. And note that not all feature combinations are allowed.

FIG. 15 is an illustration of an example of PRACH occasion partitioning and feature association when the feature association cycle spans two SSB to PRACH occasion mapping cycles. Four SSBs (with indexes 0-3) and eight features (F1-F8) are used in the example and each SSB index maps to eight frequency multiplexed PRACH occasions. The PRACH occasions that constitute one partitioning set are framed with thick, grey, dashed frames. In this example, the number of PRACH occasions associated with each feature differs between the features. Feature combinations that may be signaled are limited to combinations of two features. And note that not all feature combinations are allowed.

FIG. 16 is an illustration of an example of PRACH occasion partitioning and feature association when the feature association cycle spans two SSB to PRACH occasion mapping cycles. Four SSBs (with indexes 0-3) and twelve features (F1-F12) are used in the example and each SSB index maps to eight frequency multiplexed PRACH occasions. In addition to PRACH occasion partitioning, preamble range partitioning is used for most of the PRACH occasions (where the division of a PRACH occasion into two preamble range partitions is indicated by a dashed horizontal line. The PRACH occasions that constitute one partitioning set are framed with thick, grey, dashed frames. Feature combinations that may be signaled are limited to combinations of two features. And note that not all feature combinations are allowed.

This type of expansion of the partitioning unit allows the signaling of more features to be supported without “over-populating” the same shared PRACH occasions, at the cost of sparser PRACH occasions available for signaling of each specific feature.

Alternatives to extending the partitioning set (and the feature association cycle) include extending it across multiple association periods or one or multiple association pattern periods, e.g. with the feature association cycle equal to N association periods or N association pattern periods.

### 3.5 Signaling of Additional Combined Features

If a UE wants to signal a combination of more features than allowed with Msg1 signaling (i.e., a combination of more features than the maximum number of features supported in a combination by the configured signaling possibilities based on PRACH occasion and/or preamble range), the UE can include the further feature information in Msg3 or MsgA. To support this for Msg3, the network/gNB may allocate a larger UL grant (in the Random Access Response message) for Msg3, when it receives a preamble/PRACH occasion combination that implies that the UE may support one or more additional feature(s) that would benefit from as early special support or adaptations as possible (e.g. a preamble/PRACH occasion combination signaling a combination of two features which may be combined with one or more additional feature(s) without compatibility problems or contradicting required properties or adaptations). Similarly, if 2-step RA is used, the gNB/network may configure a larger MsgA PUSCH allocation for preamble/PRACH occasion combinations implying that the UE may support one or more additional feature(s) that would benefit from as early special support or adaptations as possible (e.g. a preamble/PRACH occasion combination signaling a combination of two features which may be combined with one or more other feature(s) without compatibility problems or contradicting required properties or adaptations. The purpose of such larger allocation sizes would be to make room for the feature signaling on top of the regular content of Msg3/MsgA (i.e., the content Msg3/MsgA would have without the additional feature signaling).

This additional option may be used together with any of the methods of feature signaling based on PRACH occasion and/or preamble range described in this document.

### 4 Further Description

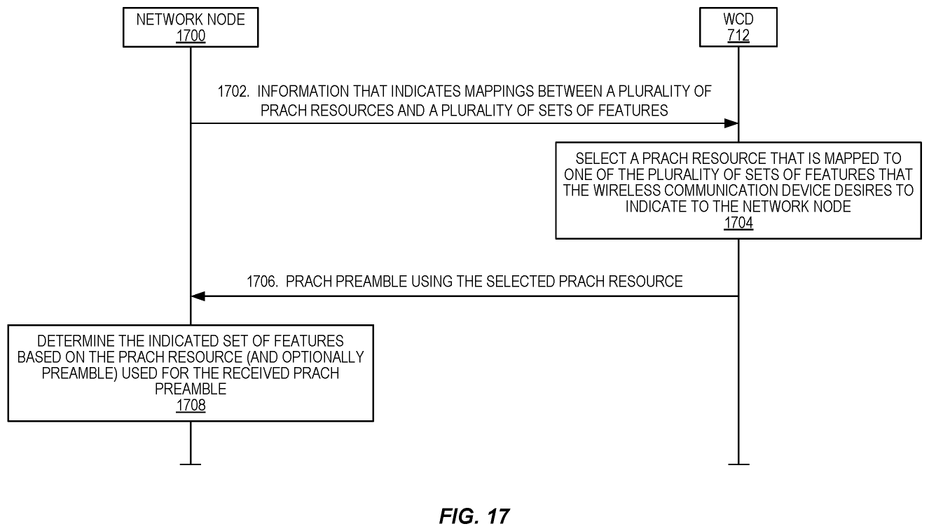

FIG. 17 illustrates the operation of a wireless communication device 712 (e.g., a UE) and a network node 1700 (e.g., a base station 702 or a network node that implements some of the functionality of a base station 702 such as, for example, a gNB-CU) in accordance with at least some of the embodiments described above. As illustrated, the network node 1700 sends, and the wireless communication device 712 receives, information that indicates mappings between a plurality of PRACH resources and a plurality of sets of features (step 1702). Note that this information may be in accordance with any of the embodiments described above. The wireless communication device 712 selects a PRACH resource from among the plurality of PRACH resources, where the selected PRACH resource is one of the PRACH resources that is mapped to one of the plurality of sets of features that the wireless communication device 712 desires to indicate to the network node 1700 (step 1704). The wireless communication device 712 then transmits a PRACH preamble using the selected PRACH resource (step 1706). The network node 1700 receives the PRACH preamble and determines the indicated set of features based on the PRACH resource in which the PRACH preamble was received (and optionally which PRACH preamble was received) (step 1708).

While all of the embodiments described above in Sections 1, 2, and 3 may be utilized in the context of the process of FIG. 17, some example embodiments are as follows.

In one embodiment, each PRACH resource of the plurality of PRACH responses is mapped to a different one of the plurality of sets of features.

In one embodiment, at least one of the plurality of sets of features is mapped to more than one of the plurality of PRACH resources.

In one embodiment, two or more of the plurality of PRACH resources, but not all of the plurality of PRACH resources, are mapped to a same set of features.

In one embodiment, each set of features from among the plurality of sets of features comprises one or more features.

In one embodiment, the information that indicates the mappings between the plurality of PRACH resources and the plurality of sets of features comprises, for each PRACH configuration of one or more PRACH configurations, information that indicates a mapping of all PRACH resources of the PRACH configuration to a particular set of features.

In one embodiment, the information that indicates the mappings between the plurality of PRACH resources and the plurality of sets of features comprises, for a PRACH configuration, information that indicates a mapping of a first subset of PRACH resources of the PRACH configuration to a first set of features and information that indicates a mapping of a second subset of the PRACH resources of the PRACH configuration to a second set of features.

In one embodiment, the information that indicates the mappings between the plurality of PRACH resources and the plurality of sets of features comprises, for a PRACH resource from among the plurality of PRACH resources, information that indicates a mapping of a first set of PRACH preambles for the PRACH resource to a first set of features and information that indicates a mapping of a second set of the PRACH preamble for the PRACH resource to a second set of features.

In one embodiment, the information that indicates the mappings between the plurality of PRACH resources and the plurality of sets of features comprises at least one bitmap.

In one embodiment, the information that indicates the mappings between the plurality of PRACH resources and the plurality of sets of features comprises, for each PRACH resource, a bitmap that indicates a set of features mapped to the PRACH resource. In one embodiment, the selected PRACH resource is a PRACH resource for which the respective bitmap indicates only the desired set of features. In one embodiment, a size of the bitmap is greater than a number of features that is currently possible to map to the PRACH resource.

In one embodiment, the information that indicates the mappings between the plurality of PRACH resources and the plurality of sets of features comprises, for each PRACH resource, a set of flags that indicates a set of features mapped to the PRACH resource.

In one embodiment, features that can be signaled via PRACH have an assumed order, and the information that indicates the mappings between the plurality of PRACH resources and the plurality of sets of features defines a PRACH partitioning in an inductive manner.

In one embodiment, features that can be signaled via PRACH have an assumed order, and the information that indicates the mappings between the plurality of PRACH resources and the plurality of sets of features.

In one embodiment, a first PRACH resource of the plurality of PRACH resources or a subset of the first PRACH resource and a second PRACH resource of the plurality of PRACH resources or a subset of the second PRACH resource are mapped to a same set of features. In one embodiment, the desired set of features to be indicated to the network node is the same set of features to which the first PRACH resource of the plurality of PRACH resources or the subset of the first PRACH resource and the second PRACH resource of the plurality of PRACH resources or the subset of the second PRACH resource are mapped, and selecting the PRACH resource comprises selecting either: (a) the first PRACH resource of the plurality of PRACH resources or the subset of the first PRACH resource or (b) the second PRACH resource of the plurality of PRACH resources or the subset of the second PRACH resource, in accordance with a selection scheme. In one embodiment, the selection scheme is a randomized selection scheme. In one embodiment, the selection scheme is such that a probability of selection of equal among the possible PRACH resources (e.g., (a) the first PRACH resource of the plurality of PRACH resources or the subset of the first PRACH resource or (b) the second PRACH resource of the plurality of PRACH resources or the subset of the second PRACH resource). In one embodiment, the selection scheme is such that a probability of selection of a PRACH resource is based on a number of PRACH preambles in the PRACH resource. In one embodiment, the selection scheme is such that a particular PRACH preamble is selected and all preambles in the possible PRACH resources (e.g., (a) the first PRACH resource of the plurality of PRACH resources or the subset of the first PRACH resource or (b) the second PRACH resource of the plurality of PRACH resources or the subset of the second PRACH resource) have equal probability of being selected. In one embodiment, the selection scheme is such that a probability of selection of a PRACH resource from the possible PRACH resources is based on a number of PRACH preambles in the PRACH resource and an amount of time until the PRACH resource. In one embodiment, the selection scheme is a selection scheme that selects a PRACH resource (e.g., from among the possible PRACH resources) that is next in time.

In one embodiment, the plurality of PRACH resources are associated to a new PRACH (i.e., a PRACH other than a legacy PRACH). In one embodiment, the information that indicates the mappings between the plurality of PRACH resources and the plurality of sets of features comprises at least one bitmap. In one embodiment, the information that indicates the mappings between the plurality of PRACH resources and the plurality of sets of features comprises, for each feature of a plurality of features, a bitmap that indicates one or more of the plurality of PRACH resources that are mapped to the feature.

In one embodiment, the plurality of PRACH resources form a plurality of PRACH occasions, the plurality of PRACH occasions being a common pool of PRACH occasions dedicated for feature signaling. Further, the information that indicates the mappings between the plurality of PRACH resources and the plurality of sets of features comprises, for each of a plurality of features, a feature configuration that comprises information that indicates one or more PRACH occasions (e.g., and optionally one or more sets of preambles) from the common pool of PRACH occasions dedicated for feature signaling that are mapped to the feature. In one embodiment, the plurality of PRACH occasions and/or associated preamble ranges are prepared to simplify indications of the mappings from the feature configurations. In one embodiment, a mapping between a feature and one or more preamble ranges in a PRACH resource to which the feature is mapped is defined based on a rule(s).

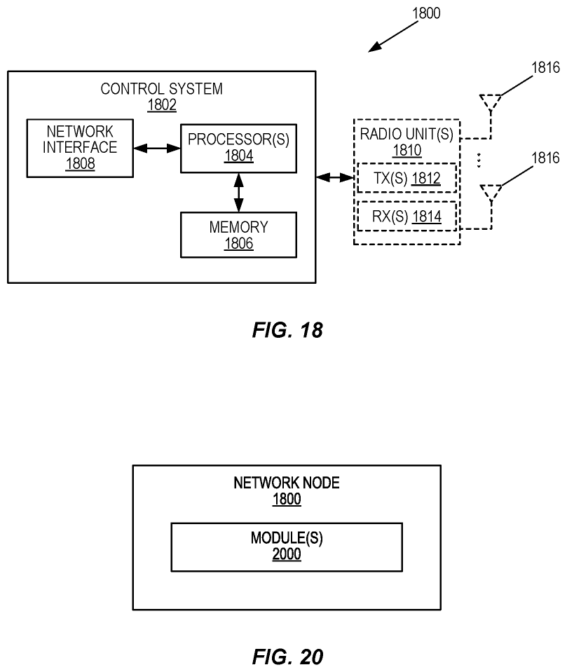

FIG. 18 is a schematic block diagram of a network node 1800 according to some embodiments of the present disclosure. Optional features are represented by dashed boxes. The network node 1800 may be, for example, a base station 702 or 706 or a network node that implements all or part of the functionality of the base station 702 or gNB described herein. As illustrated, the network node 1800 includes a control system 1802 that includes one or more processors 1804 (e.g., Central Processing Units (CPUs), Application Specific Integrated Circuits (ASICs), Field Programmable Gate Arrays (FPGAs), and/or the like), memory 1806, and a network interface 1808. The one or more processors 1804 are also referred to herein as processing circuitry. In addition, if the network node 1800 is a radio access node (e.g., a base station 702, gNB, or network node that implements at least some of the functionality of the base station 702 or gNB), the network node 1800 may include one or more radio units 1810 that each includes one or more transmitters 1812 and one or more receivers 1814 coupled to one or more antennas 1816. The radio units 1810 may be referred to or be part of radio interface circuitry. In some embodiments, the radio unit(s) 1810 is external to the control system 1802 and connected to the control system 1802 via, e.g., a wired connection (e.g., an optical cable). However, in some other embodiments, the radio unit(s) 1810 and potentially the antenna(s) 1816 are integrated together with the control system 1802. The one or more processors 1804 operate to provide one or more functions of the network node 1800 as described herein (e.g., one or more functions of a base station 702 or gNB described herein). In some embodiments, the function(s) are implemented in software that is stored, e.g., in the memory 1806 and executed by the one or more processors 1804.

FIG. 19 is a schematic block diagram that illustrates a virtualized embodiment of the network node 1800 according to some embodiments of the present disclosure. Again, optional features are represented by dashed boxes. As used herein, a “virtualized” network node is an implementation of the network node 1800 in which at least a portion of the functionality of the network node 1800 is implemented as a virtual component(s) (e.g., via a virtual machine(s) executing on a physical processing node(s) in a network(s)). As illustrated, in this example, if the network node 1800 is a radio access node, the network node 1800 may include the control system 1802 and/or the one or more radio units 1810, as described above. The control system 1802 may be connected to the radio unit(s) 1810 via, for example, an optical cable or the like. The network node 1800 includes one or more processing nodes 1900 coupled to or included as part of a network(s) 1902. If present, the control system 1802 or the radio unit(s) are connected to the processing node(s) 1900 via the network 1902. Each processing node 1900 includes one or more processors 1904 (e.g., CPUs, ASICs, FPGAs, and/or the like), memory 1906, and a network interface 1908.

In this example, functions 1910 of the network node 1800 described herein (e.g., one or more functions of a base station 702 or gNB described herein) are implemented at the one or more processing nodes 1900 or distributed across the one or more processing nodes 1900 and the control system 1802 and/or the radio unit(s) 1810 in any desired manner. In some particular embodiments, some or all of the functions 1910 of the network node 1800 described herein are implemented as virtual components executed by one or more virtual machines implemented in a virtual environment(s) hosted by the processing node(s) 1900. As will be appreciated by one of ordinary skill in the art, additional signaling or communication between the processing node(s) 1900 and the control system 1802 is used in order to carry out at least some of the desired functions 1910. Notably, in some embodiments, the control system 1802 may not be included, in which case the radio unit(s) 1810 communicate directly with the processing node(s) 1900 via an appropriate network interface(s).

In some embodiments, a computer program including instructions which, when executed by at least one processor, causes the at least one processor to carry out the functionality of the network node 1800 or a node (e.g., a processing node 1900) implementing one or more of the functions 1910 of the network node 1800 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 20 is a schematic block diagram of the network node 1800 according to some other embodiments of the present disclosure. The network node 1800 includes one or more modules 2000, each of which is implemented in software. The module(s) 2000 provide the functionality of the network node 1800 described herein. This discussion is equally applicable to the processing node 1900 of FIG. 19 where the modules 2000 may be implemented at one of the processing nodes 1900 or distributed across multiple processing nodes 1900 and/or distributed across the processing node(s) 1900 and the control system 1802.

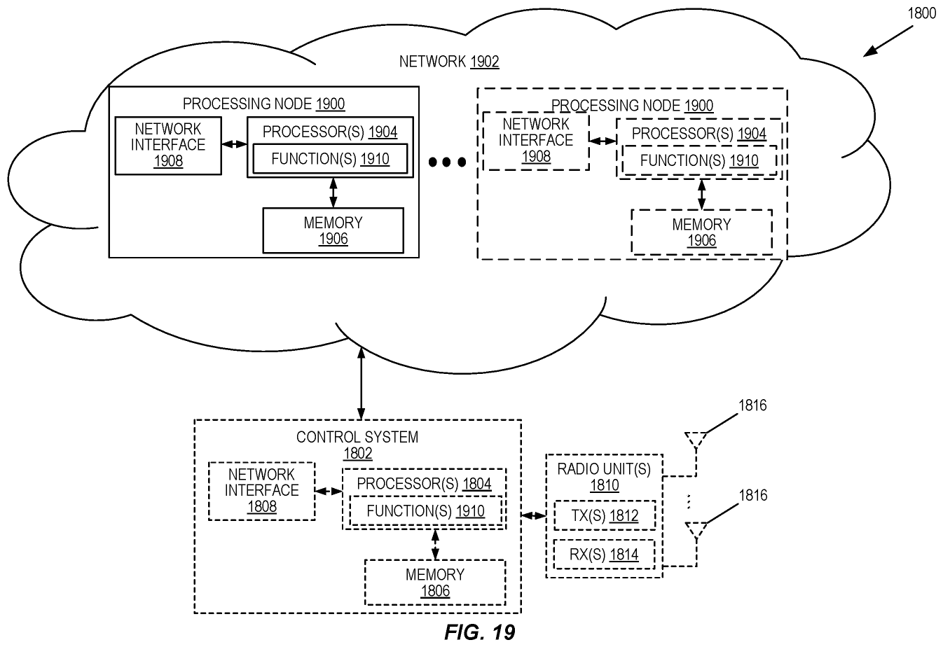

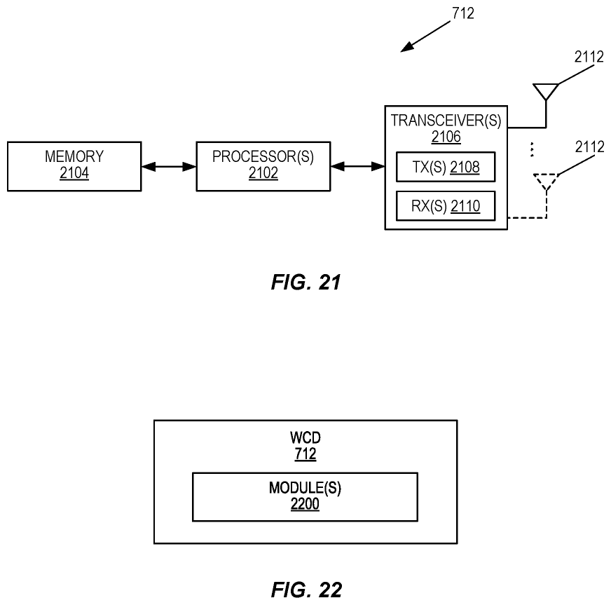

FIG. 21 is a schematic block diagram of a wireless communication device 712 (e.g., a UE) according to some embodiments of the present disclosure. As illustrated, the wireless communication device 712 includes one or more processors 2102 (e.g., CPUs, ASICs, FPGAs, and/or the like), memory 2104, and one or more transceivers 2106 each including one or more transmitters 2108 and one or more receivers 2110 coupled to one or more antennas 2112. The transceiver(s) 2106 includes radio-front end circuitry connected to the antenna(s) 2112 that is configured to condition signals communicated between the antenna(s) 2112 and the processor(s) 2102, as will be appreciated by on of ordinary skill in the art. The processors 2102 are also referred to herein as processing circuitry. The transceivers 2106 are also referred to herein as radio circuitry. In some embodiments, the functionality of the wireless communication device 712 (or UE) described above may be fully or partially implemented in software that is, e.g., stored in the memory 2104 and executed by the processor(s) 2102. Note that the wireless communication device 712 may include additional components not illustrated in FIG. 21 such as, e.g., one or more user interface components (e.g., an input/output interface including a display, buttons, a touch screen, a microphone, a speaker(s), and/or the like and/or any other components for allowing input of information into the wireless communication device 712 and/or allowing output of information from the wireless communication device 712), a power supply (e.g., a battery and associated power circuitry), etc.

In some embodiments, a computer program including instructions which, when executed by at least one processor, causes the at least one processor to carry out the functionality of the wireless communication device 712 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 22 is a schematic block diagram of the wireless communication device 712 according to some other embodiments of the present disclosure. The wireless communication device 712 includes one or more modules 2200, each of which is implemented in software. The module(s) 2200 provide the functionality of the wireless communication device 712 (or UE) described herein.

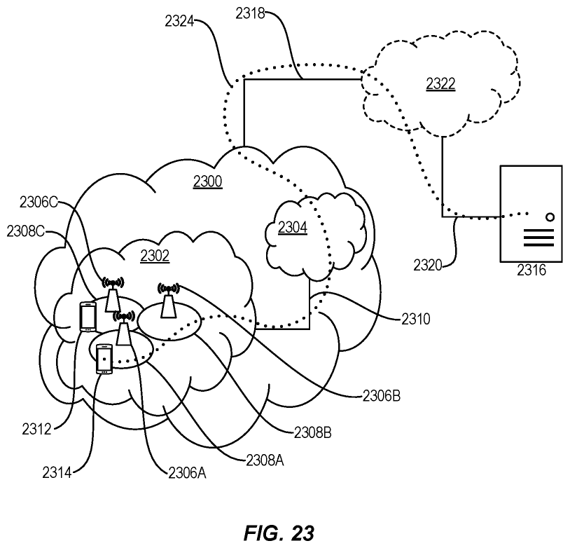

With reference to FIG. 23, in accordance with an embodiment, a communication system includes a telecommunication network 2300, such as a 3GPP-type cellular network, which comprises an access network 2302, such as a RAN, and a core network 2304. The access network 2302 comprises a plurality of base stations 2306A, 2306B, 2306C, such as Node Bs, eNBs, gNBs, or other types of wireless Access Points (APs), each defining a corresponding coverage area 2308A, 2308B, 2308C. Each base station 2306A, 2306B, 2306C is connectable to the core network 2304 over a wired or wireless connection 2310. A first UE 2312 located in coverage area 2308C is configured to wirelessly connect to, or be paged by, the corresponding base station 2306C. A second UE 2314 in coverage area 2308A is wirelessly connectable to the corresponding base station 2306A. While a plurality of UEs 2312, 2314 are illustrated in this example, the disclosed embodiments are equally applicable to a situation where a sole UE is in the coverage area or where a sole UE is connecting to the corresponding base station 2306.

The telecommunication network 2300 is itself connected to a host computer 2316, which may be embodied in the hardware and/or software of a standalone server, a cloud-implemented server, a distributed server, or as processing resources in a server farm. The host computer 2316 may be under the ownership or control of a service provider, or may be operated by the service provider or on behalf of the service provider. Connections 2318 and 2320 between the telecommunication network 2300 and the host computer 2316 may extend directly from the core network 2304 to the host computer 2316 or may go via an optional intermediate network 2322. The intermediate network 2322 may be one of, or a combination of more than one of, a public, private, or hosted network; the intermediate network 2322, if any, may be a backbone network or the Internet; in particular, the intermediate network 2322 may comprise two or more sub-networks (not shown).

The communication system of FIG. 23 as a whole enables connectivity between the connected UEs 2312, 2314 and the host computer 2316. The connectivity may be described as an Over-the-Top (OTT) connection 2324. The host computer 2316 and the connected UEs 2312, 2314 are configured to communicate data and/or signaling via the OTT connection 2324, using the access network 2302, the core network 2304, any intermediate network 2322, and possible further infrastructure (not shown) as intermediaries. The OTT connection 2324 may be transparent in the sense that the participating communication devices through which the OTT connection 2324 passes are unaware of routing of uplink and downlink communications. For example, the base station 2306 may not or need not be informed about the past routing of an incoming downlink communication with data originating from the host computer 2316 to be forwarded (e.g., handed over) to a connected UE 2312. Similarly, the base station 2306 need not be aware of the future routing of an outgoing uplink communication originating from the UE 2312 towards the host computer 2316.

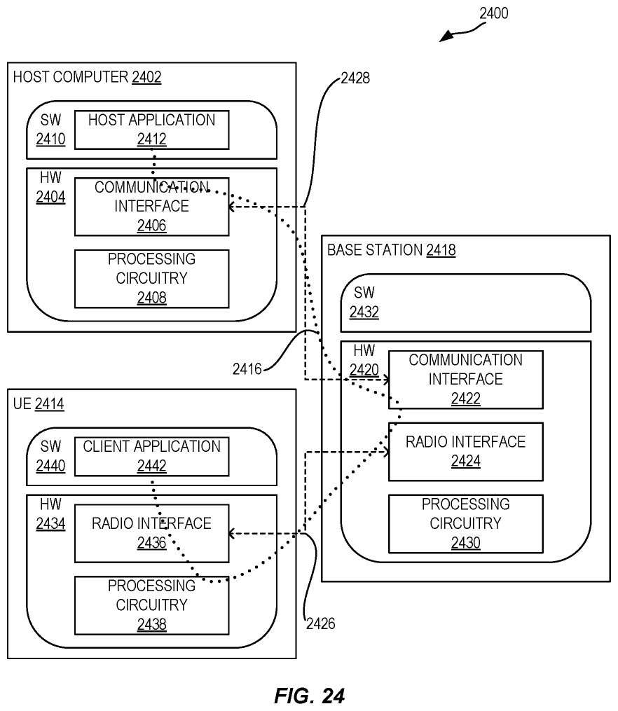

Example implementations, in accordance with an embodiment, of the UE, base station, and host computer discussed in the preceding paragraphs will now be described with reference to FIG. 24. In a communication system 2400, a host computer 2402 comprises hardware 2404 including a communication interface 2406 configured to set up and maintain a wired or wireless connection with an interface of a different communication device of the communication system 2400. The host computer 2402 further comprises processing circuitry 2408, which may have storage and/or processing capabilities. In particular, the processing circuitry 2408 may comprise one or more programmable processors, ASICs, FPGAs, or combinations of these (not shown) adapted to execute instructions. The host computer 2402 further comprises software 2410, which is stored in or accessible by the host computer 2402 and executable by the processing circuitry 2408. The software 2410 includes a host application 2412. The host application 2412 may be operable to provide a service to a remote user, such as a UE 2414 connecting via an OTT connection 2416 terminating at the UE 2414 and the host computer 2402. In providing the service to the remote user, the host application 2412 may provide user data which is transmitted using the OTT connection 2416.

The communication system 2400 further includes a base station 2418 provided in a telecommunication system and comprising hardware 2420 enabling it to communicate with the host computer 2402 and with the UE 2414. The hardware 2420 may include a communication interface 2422 for setting up and maintaining a wired or wireless connection with an interface of a different communication device of the communication system 2400, as well as a radio interface 2424 for setting up and maintaining at least a wireless connection 2426 with the UE 2414 located in a coverage area (not shown in FIG. 24) served by the base station 2418. The communication interface 2422 may be configured to facilitate a connection 2428 to the host computer 2402. The connection 2428 may be direct or it may pass through a core network (not shown in FIG. 24) of the telecommunication system and/or through one or more intermediate networks outside the telecommunication system. In the embodiment shown, the hardware 2420 of the base station 2418 further includes processing circuitry 2430, which may comprise one or more programmable processors, ASICs, FPGAs, or combinations of these (not shown) adapted to execute instructions. The base station 2418 further has software 2432 stored internally or accessible via an external connection.

The communication system 2400 further includes the UE 2414 already referred to. The UE's 2414 hardware 2434 may include a radio interface 2436 configured to set up and maintain a wireless connection 2426 with a base station serving a coverage area in which the UE 2414 is currently located. The hardware 2434 of the UE 2414 further includes processing circuitry 2438, which may comprise one or more programmable processors, ASICs, FPGAs, or combinations of these (not shown) adapted to execute instructions. The UE 2414 further comprises software 2440, which is stored in or accessible by the UE 2414 and executable by the processing circuitry 2438. The software 2440 includes a client application 2442. The client application 2442 may be operable to provide a service to a human or non-human user via the UE 2414, with the support of the host computer 2402. In the host computer 2402, the executing host application 2412 may communicate with the executing client application 2442 via the OTT connection 2416 terminating at the UE 2414 and the host computer 2402. In providing the service to the user, the client application 2442 may receive request data from the host application 2412 and provide user data in response to the request data. The OTT connection 2416 may transfer both the request data and the user data. The client application 2442 may interact with the user to generate the user data that it provides.

It is noted that the host computer 2402, the base station 2418, and the UE 2414 illustrated in FIG. 24 may be similar or identical to the host computer 2316, one of the base stations 2306A, 2306B, 2306C, and one of the UEs 2312, 2314 of FIG. 23, respectively. This is to say, the inner workings of these entities may be as shown in FIG. 24 and independently, the surrounding network topology may be that of FIG. 23.

In FIG. 24, the OTT connection 2416 has been drawn abstractly to illustrate the communication between the host computer 2402 and the UE 2414 via the base station 2418 without explicit reference to any intermediary devices and the precise routing of messages via these devices. The network infrastructure may determine the routing, which may be configured to hide from the UE 2414 or from the service provider operating the host computer 2402, or both. While the OTT connection 2416 is active, the network infrastructure may further take decisions by which it dynamically changes the routing (e.g., on the basis of load balancing consideration or reconfiguration of the network).

The wireless connection 2426 between the UE 2414 and the base station 2418 is in accordance with the teachings of the embodiments described throughout this disclosure. One or more of the various embodiments improve the performance of OTT services provided to the UE 2414 using the OTT connection 2416, in which the wireless connection 2426 forms the last segment.

A measurement procedure may be provided for the purpose of monitoring data rate, latency, and other factors on which the one or more embodiments improve. There may further be an optional network functionality for reconfiguring the OTT connection 2416 between the host computer 2402 and the UE 2414, in response to variations in the measurement results. The measurement procedure and/or the network functionality for reconfiguring the OTT connection 2416 may be implemented in the software 2410 and the hardware 2404 of the host computer 2402 or in the software 2440 and the hardware 2434 of the UE 2414, or both. In some embodiments, sensors (not shown) may be deployed in or in association with communication devices through which the OTT connection 2416 passes; the sensors may participate in the measurement procedure by supplying values of the monitored quantities exemplified above, or supplying values of other physical quantities from which the software 2410, 2440 may compute or estimate the monitored quantities. The reconfiguring of the OTT connection 2416 may include message format, retransmission settings, preferred routing, etc.; the reconfiguring need not affect the base station 2418, and it may be unknown or imperceptible to the base station 2418. Such procedures and functionalities may be known and practiced in the art. In certain embodiments, measurements may involve proprietary UE signaling facilitating the host computer 2402's measurements of throughput, propagation times, latency, and the like. The measurements may be implemented in that the software 2410 and 2440 causes messages to be transmitted, in particular empty or ‘dummy’ messages, using the OTT connection 2416 while it monitors propagation times, errors, etc.

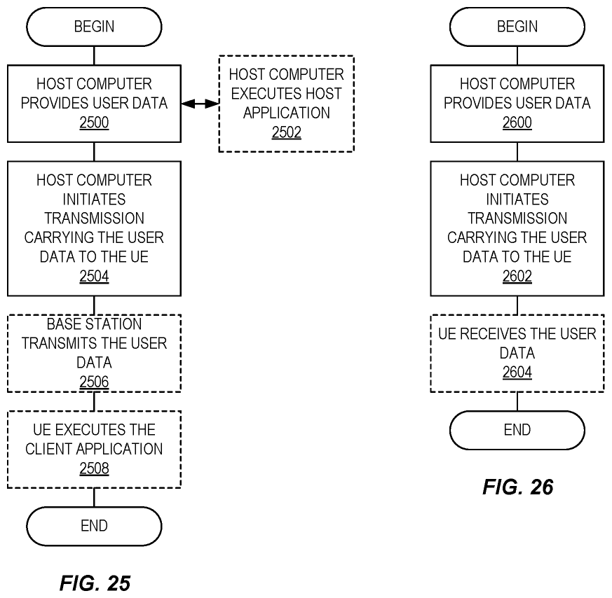

FIG. 25 is a flowchart illustrating a method implemented in a communication system, in accordance with one embodiment. The communication system includes a host computer, a base station, and a UE which may be those described with reference to FIGS. 23 and 24. For simplicity of the present disclosure, only drawing references to FIG. 25 will be included in this section. In step 2500, the host computer provides user data. In sub-step 2502 (which may be optional) of step 2500, the host computer provides the user data by executing a host application. In step 2504, the host computer initiates a transmission carrying the user data to the UE. In step 2506 (which may be optional), the base station transmits to the UE the user data which was carried in the transmission that the host computer initiated, in accordance with the teachings of the embodiments described throughout this disclosure. In step 2508 (which may also be optional), the UE executes a client application associated with the host application executed by the host computer.

FIG. 26 is a flowchart illustrating a method implemented in a communication system, in accordance with one embodiment. The communication system includes a host computer, a base station, and a UE which may be those described with reference to FIGS. 23 and 24. For simplicity of the present disclosure, only drawing references to FIG. 26 will be included in this section. In step 2600 of the method, the host computer provides user data. In an optional sub-step (not shown) the host computer provides the user data by executing a host application. In step 2602, the host computer initiates a transmission carrying the user data to the UE. The transmission may pass via the base station, in accordance with the teachings of the embodiments described throughout this disclosure. In step 2604 (which may be optional), the UE receives the user data carried in the transmission.

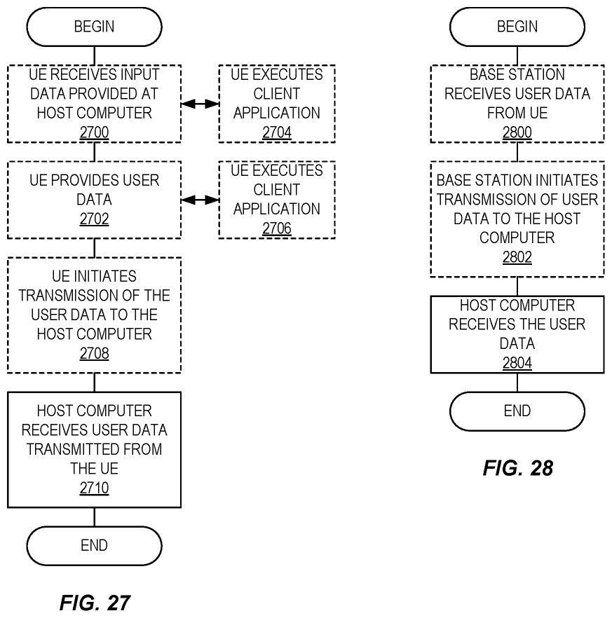

FIG. 27 is a flowchart illustrating a method implemented in a communication system, in accordance with one embodiment. The communication system includes a host computer, a base station, and a UE which may be those described with reference to FIGS. 23 and 24. For simplicity of the present disclosure, only drawing references to FIG. 27 will be included in this section. In step 2700 (which may be optional), the UE receives input data provided by the host computer. Additionally or alternatively, in step 2702, the UE provides user data. In sub-step 2704 (which may be optional) of step 2700, the UE provides the user data by executing a client application. In sub-step 2706 (which may be optional) of step 2702, the UE executes a client application which provides the user data in reaction to the received input data provided by the host computer. In providing the user data, the executed client application may further consider user input received from the user. Regardless of the specific manner in which the user data was provided, the UE initiates, in sub-step 2708 (which may be optional), transmission of the user data to the host computer. In step 2710 of the method, the host computer receives the user data transmitted from the UE, in accordance with the teachings of the embodiments described throughout this disclosure.

FIG. 28 is a flowchart illustrating a method implemented in a communication system, in accordance with one embodiment. The communication system includes a host computer, a base station, and a UE which may be those described with reference to FIGS. 23 and 24. For simplicity of the present disclosure, only drawing references to FIG. 28 will be included in this section. In step 2800 (which may be optional), in accordance with the teachings of the embodiments described throughout this disclosure, the base station receives user data from the UE. In step 2802 (which may be optional), the base station initiates transmission of the received user data to the host computer. In step 2804 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method performed by a wireless communication device (712), the method comprising: receiving (1702), from a network node (1700; 702), information that indicates mappings between a plurality of Physical Random Access Channel, PRACH, resources and a plurality of sets of features; selecting (1704) a PRACH resource from among the plurality of PRACH resources, the selected PRACH resource being mapped to one of the plurality of sets of features that the wireless communication device (712) desires to indicate to the network node (1700; 702); and transmitting (1706) a PRACH preamble using the selected PRACH resource.

Embodiment 2: The method of embodiment 1 wherein each PRACH resource of the plurality of PRACH resources is mapped to a different one of the plurality of sets of features.

Embodiment 3: The method of embodiment 1 wherein at least one of the plurality of sets of features is mapped to more than one of the plurality of PRACH resources.

Embodiment 4: The method of embodiment 1 wherein two or more of the plurality of PRACH resources, but not all of the plurality of PRACH resources, are mapped to a same set of features.

Embodiment 5: The method of any of embodiments 1 to 4 wherein each set of features from among the plurality of sets of features comprises one or more features.

Embodiment 6: The method of any of embodiments 1 to 5 wherein the information that indicates the mappings between the plurality of PRACH resources and the plurality of sets of features comprises, for each PRACH configuration of one or more PRACH configurations, information that indicates a mapping of all PRACH resources of the PRACH configuration to a particular set of features.

Embodiment 7: The method of any of embodiments 1 to 5 wherein the information that indicates the mappings between the plurality of PRACH resources and the plurality of sets of features comprises, for a PRACH configuration, information that indicates a mapping of a first subset of PRACH resources of the PRACH configuration to a first set of features and information that indicates a mapping of a second subset of the PRACH resources of the PRACH configuration to a second set of features.

Embodiment 8: The method of any of embodiments 1 to 5 wherein the information that indicates the mappings between the plurality of PRACH resources and the plurality of sets of features comprises, for a PRACH resource from among the plurality of PRACH resources, information that indicates a mapping of a first set of PRACH preambles for the PRACH resource to a first set of features and information that indicates a mapping of a second set of the PRACH preamble for the PRACH resource to a second set of features.

Embodiment 9: The method of any of embodiments 1 to 8 wherein the information that indicates the mappings between the plurality of PRACH resources and the plurality of sets of features comprises at least one bitmap.

Embodiment 10: The method of any of embodiments 1 to 8 wherein the information that indicates the mappings between the plurality of PRACH resources and the plurality of sets of features comprises, for each PRACH resource, a bitmap that indicates a set of features mapped to the PRACH resource.

Embodiment 11: The method of embodiment 10 wherein the selected PRACH resource is a PRACH resource for which the respective bitmap indicates only the desired set of features.

Embodiment 12: The method of embodiment 10 or 11 wherein a size of the bitmap is greater than a number of features that is currently possible to map to the PRACH resource.

Embodiment 13: The method of any of embodiments 1 to 8 wherein the information that indicates the mappings between the plurality of PRACH resources and the plurality of sets of features comprises, for each PRACH resource, a set of flags that indicates a set of features mapped to the PRACH resource.

Embodiment 14: The method of any of embodiments 1 to 8 wherein features that can be signaled via PRACH have an assumed order, and the information that indicates the mappings between the plurality of PRACH resources and the plurality of sets of features defines a PRACH partitioning in an inductive manner.

Embodiment 15: The method of any of embodiments 1 to 8 wherein features that can be signaled via PRACH have an assumed order, and the information that indicates the mappings between the plurality of PRACH resources and the plurality of sets of features.

Embodiment 16: The method of any of embodiments 1 and 5 to 15 wherein a first PRACH resource of the plurality of PRACH resources or a subset of the first PRACH resource and a second PRACH resource of the plurality of PRACH resources or a subset of the second PRACH resource are mapped to a same set of features.

Embodiment 17: The method of embodiment 16 wherein the desired set of features to be indicated to the network node is the same set of features to which the first PRACH resource of the plurality of PRACH resources or the subset of the first PRACH resource and the second PRACH resource of the plurality of PRACH resources or the subset of the second PRACH resource are mapped, and selecting (1704) the PRACH resource comprises selecting (1704) either: (a) the first PRACH resource of the plurality of PRACH resources or the subset of the first PRACH resource or (b) the second PRACH resource of the plurality of PRACH resources or the subset of the second PRACH resource, in accordance with a selection scheme.

Embodiment 18: The method of embodiment 17 wherein the selection scheme is a randomized selection scheme.

Embodiment 19: The method of embodiment 17 wherein the selection scheme is such that a probability of selection of equal among the possible PRACH resources (e.g., (a) the first PRACH resource of the plurality of PRACH resources or the subset of the first PRACH resource or (b) the second PRACH resource of the plurality of PRACH resources or the subset of the second PRACH resource).

Embodiment 20: The method of embodiment 17 wherein the selection scheme is such that a probability of selection of a PRACH resource is based on a number of PRACH preambles in the PRACH resource.

Embodiment 21: The method of embodiment 17 wherein the selection scheme is such that a particular PRACH preamble is selected and all preambles in the possible PRACH resources (e.g., (a) the first PRACH resource of the plurality of PRACH resources or the subset of the first PRACH resource or (b) the second PRACH resource of the plurality of PRACH resources or the subset of the second PRACH resource) have equal probability of being selected.

Embodiment 22: The method of embodiment 17 wherein the selection scheme is such that a probability of selection of a PRACH resource from the possible PRACH resources is based on a number of PRACH preambles in the PRACH resource and an amount of time until the PRACH resource.

Embodiment 23: The method of embodiment 17 wherein the selection scheme is a selection scheme that selects a PRACH resource (e.g., from among the possible PRACH resources) that is next in time.

Embodiment 24: The method of any of embodiments 1 to 5 wherein the plurality of PRACH resources are associated to a new PRACH (i.e., a PRACH other than a legacy PRACH).

Embodiment 25: The method of embodiment 24 wherein the information that indicates the mappings between the plurality of PRACH resources and the plurality of sets of features comprises at least one bitmap.

Embodiment 26: The method of embodiment 24 wherein the information that indicates the mappings between the plurality of PRACH resources and the plurality of sets of features comprises, for each feature of a plurality of features, a bitmap that indicates one or more of the plurality of PRACH resources that are mapped to the feature.

Embodiment 27: The method of any of embodiments 1 to 5 wherein: the plurality of PRACH resources form a plurality of PRACH occasions, the plurality of PRACH occasions being a common pool of PRACH occasions dedicated for feature signaling; and the information that indicates the mappings between the plurality of PRACH resources and the plurality of sets of features comprises, for each of a plurality of features, a feature configuration that comprises information that indicates one or more PRACH occasions (e.g., and optionally one or more sets of preambles) from the common pool of PRACH occasions dedicated for feature signaling that are mapped to the feature.

Embodiment 28: The method of embodiment 27 wherein the plurality of PRACH occasions and/or associated preamble ranges are prepared to simplify indications of the mappings from the feature configurations.

Embodiment 29: The method of embodiment 27 or 28 wherein a mapping between a feature and one or more preamble ranges in a PRACH resource to which the feature is mapped is defined based on a rule(s).

Embodiment 30: The method of any of the previous embodiments, further comprising: providing user data; and forwarding the user data to a host computer via the transmission to the base station.

### Group B Embodiments

Embodiment 31: A method performed by a network node, the method comprising: sending (1702), to a wireless communication device (712), information that indicates mappings between a plurality of Physical Random Access Channel, PRACH, resources and a plurality of sets of features.

Embodiment 32: The method of embodiment 31 wherein each PRACH resource of the plurality of PRACH responses is mapped to a different one of the plurality of sets of features.

Embodiment 33: The method of embodiment 31 wherein at least one of the plurality of sets of features is mapped to more than one of the plurality of PRACH resources.

Embodiment 34: The method of embodiment 31 wherein two or more of the plurality of PRACH resources, but not all of the plurality of PRACH resources, are mapped to a same set of features.

Embodiment 35: The method of any of embodiments 31 to 34 wherein each set of features from among the plurality of sets of features comprises one or more features.

Embodiment 36: The method of any of embodiments 31 to 35 wherein the information that indicates the mappings between the plurality of PRACH resources and the plurality of sets of features comprises, for each PRACH configuration of one or more PRACH configurations, information that indicates a mapping of all PRACH resources of the PRACH configuration to a particular set of features.

Embodiment 37: The method of any of embodiments 31 to 35 wherein the information that indicates the mappings between the plurality of PRACH resources and the plurality of sets of features comprises, for a PRACH configuration, information that indicates a mapping of a first subset of PRACH resources of the PRACH configuration to a first set of features and information that indicates a mapping of a second subset of the PRACH resources of the PRACH configuration to a second set of features.

Embodiment 38: The method of any of embodiments 31 to 35 wherein the information that indicates the mappings between the plurality of PRACH resources and the plurality of sets of features comprises, for a PRACH resource from among the plurality of PRACH resources, information that indicates a mapping of a first set of PRACH preambles for the PRACH resource to a first set of features and information that indicates a mapping of a second set of the PRACH preamble for the PRACH resource to a second set of features.

Embodiment 39: The method of any of embodiments 31 to 38 wherein the information that indicates the mappings between the plurality of PRACH resources and the plurality of sets of features comprises at least one bitmap.

Embodiment 40: The method of any of embodiments 31 to 38 wherein the information that indicates the mappings between the plurality of PRACH resources and the plurality of sets of features comprises, for each PRACH resource, a bitmap that indicates a set of features mapped to the PRACH resource.

Embodiment 41: The method of embodiment 40 wherein a size of the bitmap is greater than a number of features that is currently possible to map to the PRACH resource.

Embodiment 42: The method of any of embodiments 31 to 38 wherein the information that indicates the mappings between the plurality of PRACH resources and the plurality of sets of features comprises, for each PRACH resource, a set of flags that indicates a set of features mapped to the PRACH resource.

Embodiment 43: The method of any of embodiments 31 to 38 wherein features that can be signaled via PRACH have an assumed order, and the information that indicates the mappings between the plurality of PRACH resources and the plurality of sets of features defines a PRACH partitioning in an inductive manner.

Embodiment 44: The method of any of embodiments 31 to 38 wherein features that can be signaled via PRACH have an assumed order, and the information that indicates the mappings between the plurality of PRACH resources and the plurality of sets of features.

Embodiment 45: The method of any of embodiments 31 and 35 to 44 wherein a first PRACH resource of the plurality of PRACH resources or a subset of the first PRACH resource and a second PRACH resource of the plurality of PRACH resources or a subset of the second PRACH resource are mapped to a same set of features.

Embodiment 46: The method of any of embodiments 31 to 35 wherein the plurality of PRACH resources are associated to a new PRACH (i.e., a PRACH other than a legacy PRACH).

Embodiment 47: The method of embodiment 46 wherein the information that indicates the mappings between the plurality of PRACH resources and the plurality of sets of features comprises at least one bitmap.

Embodiment 48: The method of embodiment 46 wherein the information that indicates the mappings between the plurality of PRACH resources and the plurality of sets of features comprises, for each feature of a plurality of features, a bitmap that indicates one or more of the plurality of PRACH resources that are mapped to the feature.

Embodiment 49: The method of any of embodiments 31 to 35 wherein: the plurality of PRACH resources form a plurality of PRACH occasions, the plurality of PRACH occasions being a common pool of PRACH occasions dedicated for feature signaling; and the information that indicates the mappings between the plurality of PRACH resources and the plurality of sets of features comprises, for each of a plurality of features, a feature configuration that comprises information that indicates one or more PRACH occasions (e.g., and optionally one or more sets of preambles) from the common pool of PRACH occasions dedicated for feature signaling that are mapped to the feature.

Embodiment 50: The method of embodiment 49 wherein the plurality of PRACH occasions and/or associated preamble ranges are prepared to simplify indications of the mappings from the feature configurations.

Embodiment 51: The method of embodiment 49 or 50 wherein a mapping between a feature and one or more preamble ranges in a PRACH resource to which the feature is mapped is defined based on a rule(s).

Embodiment 52: The method of any of the previous embodiments, further comprising: obtaining user data; and forwarding the user data to a host computer or a wireless communication device.

### Group C Embodiments

Embodiment 53: A wireless communication device comprising: processing circuitry configured to perform any of the steps of any of the Group A embodiments; and power supply circuitry configured to supply power to the wireless communication device.

Embodiment 54: A network node comprising: processing circuitry configured to perform any of the steps of any of the Group B embodiments; and power supply circuitry configured to supply power to the network node.

Embodiment 55: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 56: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 57: The communication system of the previous embodiment further including the base station.

Embodiment 58: The communication system of the previous 2 embodiments, further including the UE, wherein the UE is configured to communicate with the base station.

Embodiment 59: The communication system of the previous 3 embodiments, wherein: the processing circuitry of the host computer is configured to execute a host application, thereby providing the user data; and the UE comprises processing circuitry configured to execute a client application associated with the host application.

Embodiment 60: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 61: The method of the previous embodiment, further comprising, at the base station, transmitting the user data.

Embodiment 62: The method of the previous 2 embodiments, wherein the user data is provided at the host computer by executing a host application, the method further comprising, at the UE, executing a client application associated with the host application.

Embodiment 63: A User Equipment, UE, configured to communicate with a base station, the UE comprising a radio interface and processing circuitry configured to perform the method of the previous 3 embodiments.

Embodiment 64: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 65: The communication system of the previous embodiment, wherein the cellular network further includes a base station configured to communicate with the UE.

Embodiment 66: The communication system of the previous 2 embodiments, wherein: the processing circuitry of the host computer is configured to execute a host application, thereby providing the user data; and the UE's processing circuitry is configured to execute a client application associated with the host application.

Embodiment 67: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 68: The method of the previous embodiment, further comprising at the UE, receiving the user data from the base station.

Embodiment 69: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 70: The communication system of the previous embodiment, further including the UE.

Embodiment 71: The communication system of the previous 2 embodiments, further including the base station, wherein the base station comprises a radio interface configured to communicate with the UE and a communication interface configured to forward to the host computer the user data carried by a transmission from the UE to the base station.

Embodiment 72: The communication system of the previous 3 embodiments, wherein: the processing circuitry of the host computer is configured to execute a host application; and the UE's processing circuitry is configured to execute a client application associated with the host application, thereby providing the user data.

Embodiment 73: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 74: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 75: The method of the previous embodiment, further comprising, at the UE, providing the user data to the base station.

Embodiment 76: The method of the previous 2 embodiments, further comprising: at the UE, executing a client application, thereby providing the user data to be transmitted; and at the host computer, executing a host application associated with the client application.

Embodiment 77: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 78: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 79: The communication system of the previous embodiment further including the base station.

Embodiment 80: The communication system of the previous 2 embodiments, further including the UE, wherein the UE is configured to communicate with the base station.

Embodiment 81: The communication system of the previous 3 embodiments, wherein: the processing circuitry of the host computer is configured to execute a host application; and the UE is configured to execute a client application associated with the host application, thereby providing the user data to be received by the host computer.

Embodiment 82: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 83: The method of the previous embodiment, further comprising at the base station, receiving the user data from the UE.

Embodiment 84: The method of the previous 2 embodiments, further comprising at the base station, initiating a transmission of the received user data to the host computer.

Those skilled in the art will recognize improvements and modifications to the embodiments of the present disclosure. All such improvements and modifications are considered within the scope of the concepts disclosed herein.

1-61. (canceled)

62. A method performed by a wireless communication device, the method comprising:
receiving, from a network node, information that indicates mappings between a plurality of Physical Random Access Channel, PRACH, resources and a plurality of sets of features;
selecting a PRACH resource from among the plurality of PRACH resources, the received information indicating a mapping between the selected PRACH resource and a set of features of the plurality of sets of features; and
transmitting a PRACH preamble using the selected PRACH resource, for indicating the set of features to the network node,
wherein the information that indicates the mappings between the plurality of PRACH resources and the plurality of sets of features comprises, for each PRACH resource of the plurality of PRACH resources, a set of flags that indicates a set of features mapped to the PRACH resource,
wherein at least one of the plurality of sets of features comprises more than one feature.

63. The method of claim 62, wherein each PRACH resource of the plurality of PRACH resources is mapped to a different one of the plurality of sets of features.

64. The method of claim 62, wherein at least one of the plurality of sets of features is mapped to more than one of the plurality of PRACH resources.

65. The method of claim 62, wherein two or more of the plurality of PRACH resources, but not all of the plurality of PRACH resources, are mapped to a same set of features.

66. The method of claim 62, wherein each set of features from among the plurality of sets of features comprises one or more features.

67. The method of claim 62, wherein the information that indicates the mappings between the plurality of PRACH resources and the plurality of sets of features comprises, for a PRACH configuration, information that indicates a mapping of a first subset of PRACH resources of the PRACH configuration to a first set of features and information that indicates a mapping of a second subset of the PRACH resources of the PRACH configuration to a second set of features.

68. The method of claim 62, wherein the different subsets of the plurality of PRACH resources comprise different sets of preambles within a PRACH resource.

69. The method of claim 62, wherein the information that indicates the mappings between the plurality of PRACH resources and the plurality of sets of features comprises, for a PRACH resource from among the plurality of PRACH resources, information that indicates a mapping of a first set of PRACH preambles for the PRACH resource to a first set of features and information that indicates a mapping of a second set of the PRACH preamble for the PRACH resource to a second set of features.

70. The method of claim 62, wherein:
the plurality of PRACH resources form a plurality of PRACH occasions, the plurality of PRACH occasions being a common pool of PRACH occasions dedicated for feature signaling; and
the information that indicates the mappings between the plurality of PRACH resources and the plurality of sets of features comprises, for each of a plurality of features, a feature configuration that comprises information that indicates one or more PRACH occasions from the common pool of PRACH occasions dedicated for feature signaling that are mapped to the feature.

71. The method of claim 62, wherein a set of features of the plurality of sets of features comprises at least one of:
reduced capabilities, or
small data transmissions, or
coverage enhancement, or
slicing.

72. A wireless communication device comprising:
one or more transmitters;
one or more receivers; and
processing circuitry associated with the one or more transmitters and the one or more receivers, the processing circuitry configured to cause the wireless communication device to:
receive, from a network node, information that indicates mappings between a plurality of Physical Random Access Channel, PRACH, resources and a plurality of sets of features;
select a PRACH resource from among the plurality of PRACH resources, the received information indicating a mapping between the selected PRACH resource and a set of features of the plurality of sets of features; and
transmit a PRACH preamble using the selected PRACH resource, for indicating the set of features to the network node,
wherein the information that indicates the mappings between the plurality of PRACH resources and the plurality of sets of features comprises, for each PRACH resource of the plurality of PRACH resources, a set of flags that indicates a set of features mapped to the PRACH resource,
wherein at least one of the plurality of sets of features comprises more than one feature.

73. The wireless communication device of claim 72, wherein each PRACH resource of the plurality of PRACH resources is mapped to a different one of the plurality of sets of features.

74. The wireless communication device of claim 72, wherein at least one of the plurality of sets of features is mapped to more than one of the plurality of PRACH resources.

75. The wireless communication device of claim 72, wherein two or more of the plurality of PRACH resources, but not all of the plurality of PRACH resources, are mapped to a same set of features.

76. The wireless communication device of claim 72, wherein each set of features from among the plurality of sets of features comprises one or more features.

77. The wireless communication device of claim 72, wherein a set of features of the plurality of sets of features comprises at least one of:
reduced capabilities, or
small data transmissions, or
coverage enhancement, or
slicing.

78. A method performed by a network node, the method comprising:
sending, to a wireless communication device, information that indicates mappings between a plurality of Physical Random Access Channel, PRACH, resources and a plurality of sets of features,
wherein the information that indicates the mappings between the plurality of PRACH resources and the plurality of sets of features comprises, for each PRACH resource of the plurality of PRACH resources, a set of flags that indicates a set of features mapped to the PRACH resource,
wherein at least one of the plurality of sets of features comprises more than one feature.

79. The method of claim 78, further comprising:
receiving a PRACH preamble using a selected PRACH resource, the sent information indicating a mapping between the selected PRACH resource and a set of features of the plurality of sets of features.

80. The method of claim 79, further comprising:
determining an indicated set of features based on the PRACH resource in which the PRACH preamble was received, and optionally which PRACH preamble was received.

81. A network node comprising processing circuitry configured to cause the network node to:
send, to a wireless communication device, information that indicates mappings between a plurality of Physical Random Access Channel, PRACH, resources and a plurality of sets of features,
wherein the information that indicates the mappings between the plurality of PRACH resources and the plurality of sets of features comprises, for each PRACH resource of the plurality of PRACH resources, a set of flags that indicates a set of features mapped to the PRACH resource,
wherein at least one of the plurality of sets of features comprises more than one feature.
